(19) United States
(12) Patent Application Publication
(10) Pub. No.: US 2009/0074467 A1
(43) Pub. Date: Mar. 19, 2009

(54) IMAGE FORMING APPARATUS AND IMAGE FORMING METHOD

(76) Inventors: Takuya Seshita, Hiratsuka-shi (JP); Masayuki Ishii, Numazu-shi (JP); Hiroshi Yamashita, Numazu-shi (JP); Naohiro Watanabe, Shizuoka-ken (JP); Shinichi Wakamatsu, Numazu-shi (JP); Tsuyoshi Sugimoto, Mishima-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/209,583

(22) Filed: Sep. 12, 2008

(30) Foreign Application Priority Data
Sep. 13, 2007 (JP) 2007-238044
Oct. 25, 2007 (JP) 2007-277796

(51) Int. Cl. G03G 15/08

(52) U.S. Cl. 399/252

(57) ABSTRACT

An image forming apparatus including an image bearing member to bear a latent electrostatic image, a charging device to charge the image bearing member, an irradiating device to irradiate the image bearing member with light to form the latent electrostatic image, a developing device to develop the latent electrostatic image with toner to form a visualized image, a transfer device to transfer the visualized image to a recording medium, a lubricant application device to apply a lubricant to the surface of the image bearing member, a cleaning device to clean the surface of the image bearing member, wherein the toner has a ratio A of from 0.3 to 1.7 obtained by the following Relationship (1), particulates P comprising resin particulates and inorganic particulates are added to the toner and the resin particulates P1 have an average primary particle diameter of from 60 to 600 nm, ratio A=Mother toner BET specific surface area/Mother toner volume average particle diameter Relationship (1).

### BACKGROUND OF THE INVENTION

1. Field of the Invention

The present invention relates to an image forming apparatus and an image forming method.

2. Discussion of the Background

As illustrated in FIGS. 1 and 2, a typical image forming apparatus has processes of: uniformly charging an image formation area on the surface of an image bearing member 8 by a charging device 1; irradiating the image bearing member 8 with light by an irradiation device 2 according to image information to form a latent electrostatic image thereon; developing the latent electrostatic image with triboelectrically charged toner to obtain a toner image on the image bearing member 8; transferring the toner image on the image bearing member 8 to a recording medium fed from a paper feeder 9 by a transfer device 4 directly or by way of an intermediate transfer body; fixing the toner image on the recording medium by a fixing device 10; and removing (scraping) toner remaining on the image bearing member 8 by a cleaning device 7 after transfer. Optionally, a lubricant application device is provided on the downstream side from the transfer device 4 and on the upstream side from the cleaning device relative to the rotation direction of the image bearing member 8 to apply a lubricant to the surface of the image bearing member 8 and improve the cleaning performance. The image bearing member 8 has a cylindrical form or a belt form. These series of image formation processes are repeated for next image formation.

When it comes to a color image formation, there are two systems, which are a revolver type system and a tandem type system, both of which use the image formation processes described above. In the revolver type system, there is only one image bearing member on which each color image is formed. In the tandem type system, an image bearing member is provided for each color. The revolver type system is inexpensive. Although the tandem type system is relatively expensive, the tandem type system can produce images at a high speed. The tandem type system is has been widely used nowadays.

Below are descriptions about the charging device 1, the irradiation device 2, the developing device 3, the transfer device 4, the cleaning device 7, the lubricant application device, the toner and the lubricant for use therein, etc. including a viewpoint from image forming method.

### Charging Device and Charging Process

As the charging device 1, there are a DC system, an AC system, and a system in which AC is overlapped with DC. There can be also divided into a vicinity type charging system and a contact type charging system, and a corona discharging system, which can be typified into a system using a coroton device and a system using a scorotron device.

A corotron charger or a scorotron charger using corona discharging used to be a dominant system to charge an image bearing member. However, the charging device and the charging process using corona discharging produce a large quantity of ozone or cause a problem that by-products of NOₓ produced by corona discharging attaches to an image bearing member, resulting in image flow over time. Also, corona discharging requires a high voltage power source to apply a voltage ranging from 5 to 10 kV, which makes it difficult to reduce the cost.

In recent years, as the charging process and the charging device employed in an image forming apparatus, there have been proposed a number of contact type or vicinity type charging processes and charging devices in which a charging device is brought in contact with or provided in the vicinity of an image bearing member. Most of the drawbacks involved in the charging process and the charging device using the corona discharging are solved by these contact type or vicinity type charging devices or charging processes. However, the abrasion amount an image bearing member increases, which results in a short working life of the image bearing member. In addition, when an AC is used in the application voltage, a noise problem arises. Furthermore, since such a charging device rubs toner or paper dust on an image bearing member against the image bearing member, the surface of the image bearing member and of the charging device is contaminated. Therefore, a charging system of applying a voltage in which an AC is overlapped with a DC to a charging device to charge an image bearing member attracts attention.

### Irradiation Process and Irradiation Device

As the irradiation device 2, there are an LD, an LED and a Xenon lamp and the irradiation process is performed by these devices.

### Developing Device and Developing Process

As the developing device (process), there are a single component developing device (process) and a two component developing device (process) in which toner and carrier are mixed for development.

As the developing agent, there are two component developing agent formed of toner and carrier and a single component of a magnetic toner or a non-magnetic toner. A typical method of manufacturing these toners is a kneading and pulverization method in which a resin, a coloring agent, an external additive such as a pigment and a charge control agent are melted and kneaded and the resultant mixture is cooled down followed by pulverization and classification. However, the size and the form of the obtained toner are non-uniform and difficult to control.

Under these circumstances, studies have been made to intentionally control the particle size of toner particles to solve the problems mentioned above and an emulsification polymerization method and a dissolution suspension method for granulation in an aqueous medium have been popular in recent years.

In addition, quality images have been strongly demanded recently. In color image formation, reducing and uniforming toner particle size are especially demanded. When a toner having a wide particle size distribution is used for image formation, fine toner powder scatters or contaminates a developing sleeve, a contact type or vicinity type charging device, a cleaning blade, an image bearing member (photoreceptor), carrier, etc, which makes a significant problem. Therefore, such a toner is not suitable to obtain quality images with high reliability.

By contrast, a toner having a uniform particle size and a sharp particle size distribution has a good fine dot reproducibility because individual toner particles have good development behavior. However, such a small and uniform sized toner has a problem with regard to cleaning. Especially, it is extremely difficult to stably remove such a toner by a cleaning blade. Therefore, a variety of methods have been proposed to improve the cleaning property by elaborating toner. Among these, there is a method in which toner form is irregularized from a spherical form. By irregularizing the toner form, the fluidity of toner powder is reduced so that a cleaning blade easily stops the toner. When the toner is excessively irregularized, the behavior of the toner tends to be unstable, which leads to deterioration of fine dot reproducibility. That is, characteristics of toner, such as transfer quality, transfer efficiency and cleaning property, are affected by the toner form. Thus, an optimal designing for toner form distribution is required to obtain a toner having the characteristics mentioned above.

### Transfer Process and Transfer Device

As the transfer device 4, for example, a transfer belt, a transfer charger and a transfer roller can be used.

### Cleaning Process and Cleaning Device

As the cleaning device 7, there can be used a cleaning blade formed of polyurethane rubber, silicone rubber, nitrile rubber, chloroprene rubber, etc, fur brush, an elastic roller, a tube covered roller, non-woven fabric, etc.

Typically, cleaning in an electrophotographic image forming apparatus is performed by a cleaning blade and there used to be a great number of image forming apparatuses having a cleaning process performed only by a cleaning blade. Among high speed image forming apparatuses, there are some which includes a cleaning assistance device to avoid the status in which a large amount of toner is locally attached to the surface of an image image bearing member. In this case, when a cleaning blade is used as the cleaning device, the cleaning blade is brought in contact with the image image bearing member in a trailing or counter manner.

In the case in which removing toner on the surface of an image bearing member only by a cleaning device is not insufficient, a cleaning assistance device is provided on the downstream side from the charging device and on the upstream side from the cleaning device relative to the rotation direction of the image bearing member to improve the clenability. As such a cleaning assistance device, there can be used fur brush, an elastic roller, a tube covered roller, non-woven fabric, etc.

A typically cleaning assistance device has been provided on the upstream side from the cleaning device relative to the rotation direction of the image bearing member and the device mentioned above has been typically used. This is to mechanically stir toner entering into the cleaning process (cleaning device) and improve the cleaning property therein. Also, an image forming apparatus has been marketed in which a voltage is applied to a cleaning assistance device to improve the cleanability by controlling the polarity of toner.

In addition, in the image forming apparatus described above, usage of a toner granulated from an aqueous medium is desired in terms of quality images but the cleaning property is not secured. Therefore, an image forming apparatus using a toner having a high average circularity employs a system having a device to apply a lubricant to the surface of an image bearing member in many cases. Such a device is provided to improve the cleaning property and prevent abrasion of the image bearing member caused by discharging in the charging process and by the (vicinity type or contact type) charging device and abrasion and/or filming caused by physical contact with the cleaning device and toner.

Toner Granulated from Aqueous Medium

With regard to manufacturing of a toner granulated from an aqueous medium, unexamined published Japanese patent application No. (hereinafter referred to as JOP) 2006-221077 describes a technology in which a spherical toner is manufactured by a suspension polymerization method or an emulsification polymerization method. In addition, with regard to a spherical toner, JOPs 2005-331807 and 2005-275245 describe a technology in which a pulverized toner is subject to heat treatment to obtain a spherical toner. According to such technologies, size reduction of toner is easy.

### Lubricant Application Process and Lubricant Application Device

A lubricant is applied to an image bearing member to extend the working life thereof and improve the image quality.

The objectives of applying a lubricant are to: prevent occurrence of toner filming (adhesion); improve the transfer efficiency and prevent bad cleaning performance by making the friction index low; and prevent abrasion of an image bearing member caused by discharging in the charging process by the charging device. JOPs 2005-275244, 2005-266428 and H09-114193 and Japanese patent No. 3243597 describe technologies to achieve these objectives by applying the lubricant 5 to the image bearing member 8 to make the friction index low.

As the lubricant application process (device), there can be used a method in which a lubricant is applied to an image bearing member by a fur brush, a loop brush, a roller, a belt, etc. or a method in which a solid lubricant or powder of a lubricant is directly applied to an image bearing member. With regard to this lubricant application technology, a configuration in which a combination of cleaning assistance and lubricant application is used is employed in many cases. In this combinational use, a lubricant is applied to the surface of an image bearing member by pressing the lubricant against a cleaning assistance device provided on the upstream side from a cleaning device relative to the rotation direction of the image bearing member.

However, when the cleaning assistance device and the lubricant application device are used in combination, the lubricant is not applied to the area (i.e., image area) on the surface of the image bearing member on which remaining toner after transfer is present so that the abrasion of the image bearing member by a contact member is not sufficiently prevented.

In addition, as other technologies to apply a lubricant to an image bearing member, there is known a technology in which a lubricant is externally added to a toner so that the lubricant is applied to the surface of an image bearing member when the toner is supplied. However, in this technology, the lubricant is not applied to the image bearing member with regard to the area (i.e., non-image area) where the toner is not supplied so that it is not possible to prevent abrasion of the image bearing member caused by discharging or physical contact by a contacting member.

To solve these problems, a technology is thought out in which powder of a lubricant is directly made in contact with an image bearing member on the downstream side from the cleaning process (cleaning device) relative to the rotation of the image bearing member and a lubricant smoothing blade is provided on the downstream side from the cleaning process (cleaning device) and on the upstream side of the charging process (charging device) relative to the rotation direction of the image bearing member. In addition, another technology is thought out to uniformly apply a lubricant to the surface of an image bearing member, in which a lubricant is pressed against a lubricant application device provided on the downstream side of the cleaning process (cleaning device) relative to the rotation direction of the image bearing member and the lubricant is applied to the surface of the image bearing member by the lubricant application device. In this technology, the application status of the lubricant on the image bearing member varies depending on the application condition of the lubricant application process (lubricant application device). Therefore, a configuration in which a lubricant smoothing blade is provided on the downstream side from the lubricant application process (lubricant application device) and on the upstream side from the charging process (charging device) relative to the rotation direction of the image bearing member is employed in some cases. By using these methods, lubricant can be applied to all the surface of an image bearing member so that the surface of the image bearing member can be protected against abrasion by a contacting member.

Furthermore, JOP H08-272133 describes a technology to extend the working life of a charging device and an image bearing member in which a non-contact type charging device is used, inorganic particulates are dispersed in the photosensitive layer of an image bearing member and zinc stearate is applied as the lubricant to improve the anti-abrasion property of the image bearing member. In addition, JOP H10-142897 describes an example of the image forming apparatus including an assistance member having a blade form to uniformly and thinly attach a lubricant to the surface of an image bearing member between the charging device and the developing device and stop lubricant particles having a large particle diameter.

By the technological improvement with regard to the lubricant application methods described above, lubricant can be relatively uniformly applied to all over the surface of an image bearing member. Thereby, it is possible to prevent filming on the surface of an image bearing member, locally bad cleaning performance, and abrasion of the image bearing member due to the physical contact by a contacting member.

As described above, lubricant can be uniformly applied to the surface of all the surface of an image bearing member due to the technological improvement.

Generally, the contact type or vicinity type charging system produces a relatively less amount of a discharge product in comparison with the corona discharging system and can be operated with low electricity. However, in such charging systems, since the image bearing member and the charging member are in contact with each other or the distance between the image bearing member and the charging member is shorter than that between the image bearing member and the charging wire, it is known that hazard to the image bearing member is relatively significant in comparison with the case of the corona discharging system.

Especially, in the case of in which an AC is overlapped, discharging is repeated depending on the frequency of the AC voltage, which makes the hazard more significant. As a result, the chemical deterioration on the surface of an image bearing member proceeds, which results in peeling of the surface layer over time. When a lubricant is applied to the surface of an image bearing member, the molecule structure and the surface energy of the lubricant change, which leads to loss of lubrication property. In addition, the lubricant is gradually scraped and finally disappears.

Thereby, the attachment force between the toner and the image bearing member increases so that bad cleaning is prevented all over the width of the surface of the image bearing member but the amount of the toner slipping through the cleaning blade increases.

Furthermore, the following problem stems from the problems mentioned above. That is, the toner which has slipped through the blade is collected by a lubricant application device and attached to a solid lubricant. As the amount of the attached toner increases, the toner forms a layer on the surface of the solid lubricant, which prevents application of the lubricant to an image bearing member.

In the area where the lubricant is not applied, filming and image blur caused thereby occur.

In addition, the friction index (surface property) at the boarder of the area where the lubricant is not applied and the friction index at the area where the lubricant is applied are largely different so that the cleaning blade is broken at the boarder due to fatigue. Image deficiency occurs at the place where the blade is broken (both ends of the area where the toner forms a layer on the solid lubricant).

That is, when the lubricant is applied to all over the surface of the image bearing member, the amount of the toner which has passed through the cleaning blade increases and such toner is collected at and attached to the lubricant application device. This is found to cause the image deficiency. Therefore, a new technology is required to protect such a configuration from mechanical abrasion of the surface of an image bearing member and abrasion by discharging to use it for an extended period of time.

JOP 2007-238709 describes a solution to the problem mentioned above, which is that “An image forming method using a toner having a ratio A of from 0.3 to 1.7 obtained by the following Relationship (1) and to which inorganic particulates having an average primary particle diameter of from 60 to 600 nm and a moisture content of from 0.1 to 1.0% are externally added. Ratio A=Mother toner BET specific surface area/Mother toner volume average particle diameter Relationship (1).”

However, when the toner is further reduced in size, the same problem mentioned above (abnormal image due to adhesion of toner to lubricant) still occurs even when the solution mentioned above is taken.

The considerable reason ix as follows:

As the size of the toner particles decreases, the adhesion force between the toner and the image bearing member increases. Thereby, the number of toner particles slipping through a cleaning device increases.

The toner particles which have passed through cleaning can be collected by a lubricant application device using the electrostatic force.

However, since the total amount of the toner which has passed through cleaning increases and the adhesion force of the toner to the lubricant increases as the size of the toner particles reduces, the toner tends to form a layer on the surface of the lubricant.

### SUMMARY OF THE INVENTION

Because of these reasons, the present inventors recognize that a need exists for an image forming apparatus which produces quality images for an extended period of time using a cleaning blade and an image bearing member, even when a toner having a small particle diameter is used, a lubricant is applied to all over the surface of an image bearing member, and the amount of the toner which passes through a cleaning device increases, while avoiding attachment of the toner to the lubricant.

Accordingly, an object of the present invention is to provide an image forming apparatus which produces quality images for an extended period of time using a cleaning blade and an image bearing member, even when a toner having a small particle diameter is used, a lubricant is applied to all over the surface of an image bearing member, and the amount of the toner which passes through a cleaning device increases, while avoiding attachment of the toner to the lubricant.

Briefly this object and other objects of the present invention as hereinafter described will become more readily apparent and can be attained, either individually or in combination thereof, by an image forming apparatus including an image bearing member to bear a latent electrostatic image, a charging device to charge the image bearing member, an irradiating device to irradiate the image bearing member with light to form the latent electrostatic image, a developing device which includes a toner and develops the latent electrostatic image with the toner to form a visualized image, a transfer device to transfer the visualized image to a recording medium, a lubricant application device to apply a lubricant to the surface of the image bearing member, a cleaning device to clean the surface of the image bearing member, wherein the toner has a ratio A of from 0.3 to 1.7 obtained by the following Relationship (1), particulates P comprising resin particulates and inorganic particulates are added to the toner and the resin particulates have an average primary particle diameter of from 60 to 600 nm. Ratio A=Mother toner BET specific surface area/Mother toner volume average particle diameter Relationship (1).

It is preferred that, in the image forming apparatus mentioned above, the toner has a volume average particle diameter of from 3.0 to 5.5 μm.

It is still further preferred that, in the image forming apparatus mentioned above, the resin particulates having an average primary particle diameter of from 60 to 600 nm are attached to the toner in an amount of from 0.5 to 4.0% by weight.

It is still further preferred that, in the image forming apparatus mentioned above, the toner includes toner particles having a particle diameter of not greater than 2 μm in an amount of from 1 to 25% by number.

It is still further preferred that, in the image forming apparatus mentioned above, the toner comprises toner particles having an average circularity of from 0.950 to 0.980.

It is still further preferred that, in the image forming apparatus mentioned above, the toner includes toner particles having a circularity of from 0.97 to 1.0 in an amount of less than 40%.

It is still further preferred that, in the image forming apparatus mentioned above, the toner includes toner particles including the inorganic particulates having an average primary particle diameter of from 1 to 50 nm in an amount of from 0.5 to 4.0% by weight.

It is still further preferred that, in the image forming apparatus mentioned above, the toner is granulated from an aqueous system and comprises a binder resin, a coloring agent, a laminate inorganic mineral in which at least part of ions between metal cation layers is modified by an organic cation.

It is still further preferred that, in the image forming apparatus mentioned above, the lubricant application device is provided on the downstream side from the cleaning device and the upstream side from the charging device relative to the rotation direction of the image bearing member.

It is still further preferred that the image forming apparatus mentioned further includes a lubricant smoothing device which is provided on the downstream side from the lubricant application device and on the upstream side from the charging device relative to a rotation direction of the image bearing member.

It is still further preferred that, in the image forming apparatus mentioned above, the charging device employs a corona discharging system.

It is still further preferred that the image forming apparatus mentioned above further includes a discharge product removing device which performs controlling removing a discharge product on the surface of the image bearing member when a continuous printing number of an image pattern having an image area ratio of not greater than 5% reaches a particular number.

It is still further preferred that the image forming apparatus further a toner spitting control device to supply the toner in a predetermined amount from the developing device to the surface of the image bearing member when a continuous printing number of an image pattern having an image area ratio of not greater than a predetermined ratio reaches a particular number.

It is still further preferred that, in the image forming apparatus mentioned above, the image bearing member is a photoreceptor in which a filler is dispersed.

It is still further preferred that, in the image forming apparatus mentioned above, the image bearing member is one of an organic photoreceptor having a surface layer which is reinforced by a filler, an organic photoreceptor using a cross-linking type charge transport material and an organic photoreceptor using a cross-linking charge transport material and having a surface layer which is reinforced by a filler.

It is still further preferred that, in the image forming apparatus mentioned above, the image bearing member is an amorphous silicon photoreceptor.

As another aspect of the present invention, an image forming method is provided which includes uniformly charging the surface of an image bearing member, irradiating the surface of the image bearing member to form a latent electrostatic image, developing the latent electrostatic image with a toner to obtain a toner image, transferring the toner image to a transfer medium, applying a lubricant to the surface of the image bearing member and cleaning the surface of the image bearing member, wherein the toner has a ratio A of from 0.3 to 1.7 obtained by the following relationship (1), particulates P including resin particulates and inorganic particulate are added to the toner and the resin particulates have an average primary particle diameter of from 60 to 600 nm. Ratio A=Mother toner BET specific surface area/Mother toner volume average particle diameter Relationship (1).

It is preferred that, in the image forming method mentioned above, the toner has a volume average particle diameter of from 3.0 to 5.5 μm.

It is preferred that, in the image forming method mentioned above, charging is performed by a corona discharging system.

It is preferred that the image forming method mentioned above further includes removing a discharge product on the surface of the image bearing member.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating the entire of an image forming apparatus;

FIG. 2 is a diagram illustrating the portion related to the image bearing member in a typical image forming apparatus;

FIG. 3 is a diagram illustrating an example of the portion related to the image bearing member in the image forming apparatus of the present invention;

FIG. 4 is a diagram illustrating another example of the portion related to the image bearing member in the image forming apparatus of the present invention;

FIG. 5 is a diagram illustrating another example of the portion related to the image bearing member in the image forming apparatus of the present invention;

FIG. 6 is a diagram illustrating another example of the portion related to the image bearing member in the image forming apparatus of the present invention;

FIG. 7 is a diagram illustrating another example of the portion related to the image bearing member in the image forming apparatus of the present invention;

FIG. 8 is a diagram illustrating an example of the layer structure of the amorphous silicon of the present invention; and

FIG. 9 is a diagram illustrating the image chart used in Examples and Comparative Examples described later.

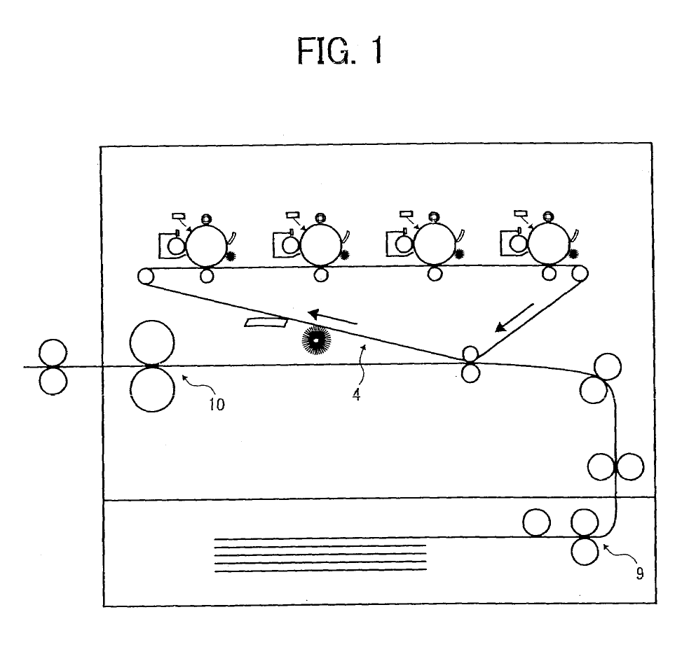

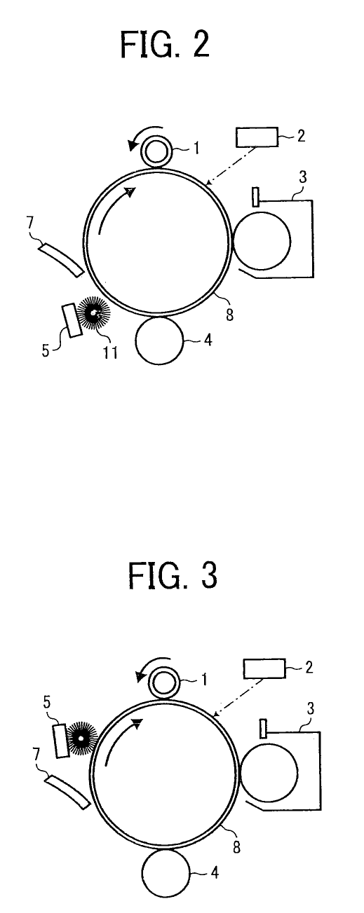

### DETAILED DESCRIPTION OF THE INVENTION

The present invention will be described below in detail with reference to several embodiments and accompanying drawings.

FIG. 3 is a diagram illustrating an example of the image forming apparatus especially suitable for the present invention. In the apparatus illustrated in FIG. 3, images are formed by: uniformly charging the image formation area on the surface of an image bearing member 8 by a charging device 1; optically writing a latent electrostatic image on the surface of the image bearing member 8 with an irradiating device 2; developing the latent electrostatic image on the image bearing member 8 with a triboelectrically charged toner by a developing device 3 to obtain a toner image; transferring the toner image by a transfer device 4 directly or by way of an intermediate transfer body to a recording medium fed from a paper feeder 9; fixing the toner image on the recording medium by a fixing device 10; removing (scraping) toner remaining on the surface of the image bearing member 8 to clean the surface thereof after transfer by a cleaning device 7. Optionally, a lubricant application device is provided on the downstream side from the transfer device 4 and on the upstream side from the cleaning device relative to the rotation direction of the image bearing member 8 to apply a lubricant to the surface of the image bearing member 8 and improve the cleaning performance. The image bearing member 8 has a cylindrical form or a belt form. These series of image formation processes are repeated for next image formation.

When such an image forming apparatus or an image forming process is applied to production of color images, there are two systems, which are a revolver type system and a tandem type system, both of which use the image formation processes described above. In the revolver type system, there is only one image bearing member on which each color image is formed. In the tandem type system, an image bearing member is provided for each color. The revolver type system is inexpensive. Although the tandem type system is relatively expensive, the tandem type system can produce images at a high speed. The tandem type system is widely used now. In the present invention, both systems can be applied.

Below are detailed descriptions about the charging device 1, the irradiation device 2, the charging device 3, the transfer device 4, the cleaning device 7, the lubricant application device, the toner and the lubricant for use therein, etc. together with the image forming method.

### Charging Device and Charging Process

As the charging device 1, there are a DC system, an AC system, and a system in which AC is overlapped with DC. There can be also divided into a vicinity type charging system and a contact type charging system, and a corona discharging system, which can be typified into a system using a coroton device and a system using a scorotron device. The charging process using such a charging device 1 is already known and thus the detailed description about the charging process is omitted.

### Irradiation Process and Irradiation Device

As the irradiation device 2, there are an LD, an LED and a Xenon lamp and the irradiation process performed by these devices. The irradiation process by a unit process using the irradiation device 2 is already known and thus the detailed description is omitted to avoid redundancy.

### Developing Device and Developing Process

As the developing device, there are a single component which includes toner as the developing agent and a two component developing device which includes toner and carrier as the developing agent to be mixed for development.

As the developing agent, there are two component developing agent formed of toner and carrier and a single component developing agent formed of a magnetic toner or a non-magnetic toner. These toners can be manufactured by a physical method such as a kneading and pulverization method in which a resin, a coloring agent, an external additive such as a pigment and a charge control agent are melted and kneaded and the resultant mixture is cooled down followed by pulverization and classification, a method in which mother toner particles are obtained by removing an organic solvent from droplets of an organic solvent in which a resin component is dissolved, various kinds of polymerization methods, and a chemical method such as partial polymerization method including elongation and/or cross-linking reaction of a resin material component for toner in an O/W type or W/O type emulsion containing the resin material for toner.

### Cleaning Process and Cleaning Device

As the cleaning device 7, there can be used a cleaning blade formed of polyurethane rubber, silicone rubber, nitrile rubber, chloroprene rubber, etc, fur brush, an elastic roller, a tube covered roller, non-woven fabric, etc. When a cleaning blade is used as the cleaning device, the cleaning blade is brought in contact with the image image bearing member in a trailing or counter manner.

### Cleaning Assistance Device

In the case in which removing toner on the surface of an image bearing member only by a cleaning device or a cleaning process is not insufficient, a cleaning assistance device can be provided on the downstream side of the transfer device or the transfer process and on the upstream side from the cleaning device or the cleaning process relative to the rotation direction of the image bearing member to improve the clenability. As such a cleaning assistance device, there can be used fur brush, an elastic roller, a tube covered roller, non-woven fabric, etc.

It is possible to apply a voltage to a cleaning assistance device to improve the cleanability by controlling the polarity of toner.

As the lubricant application process or the lubricant application device, there can be used a method in which a lubricant is applied to an image bearing member by a fur brush, a loop brush, a roller, a belt, etc. Also it is possible to use a loop brush having a structure in which the tip of hair is looped.

With regard to this lubricant application device and lubricant application method, a configuration in which a combination of cleaning assistance and lubricant application is used can be employed. In this combinational use, a lubricant is applied to the surface of an image bearing member by pressing the lubricant against a cleaning assistance device provided on the upstream side from a cleaning device relative to the rotation direction of the image bearing member as in the typical technology.

In addition, the cleaning assistance device can be provided on the downstream side from a cleaning device (cleaning process) and a lubricant application device (lubricant application process) and on the upstream side from a charging device (charging process) relative to the rotation direction of the image bearing member.

### Lubricant

As the lubricant 5, it is preferred to use a lubricant formed of a metal salt of aliphatic acid, which includes at least one aliphatic acids selected from the group consisting of stearic acid, palmitic acid, myristic acid and oleic acid and at least one metals selected from the group consisting of zinc, aluminum, calcium, magnesium, iron and lithium. In addition, the metal salt of aliphatic acid is preferably solidified from powder thereof. Minute powder is suitable as the powder before solidification. For example, zinc stearate, which is a typical lamellar crystal powder, is suitable. A lamellar crystal powder has a laminate structure in which molecules having amphipathic property are self-assembled. When a shear force is applied to such crystal powder, the crystal tends to be broken and slide along the interlayer. This function is effective to obtain a low friction index. Due to this characteristic of a lamellar crystal, the lamellar crystal uniformly covers the surface of an image bearing member, typically a photosensitive layer, when a shear force is applied. Therefore, the surface of an image bearing member 8 can be effectively covered by a small quantity of the lubricant 5.

Since metal salts of aliphatic acid has the structure of a straight chained hydrocarbon, the interlayer thereof easily slides, which is effective to obtain a good lubrication property. In addition, in the case of a straight-chained metal salt of aliphatic acid, it is possible to have a good anti-weatherability by selecting a metal.

### Lubricant Smoothing Device and Lubricant Smoothing Process

As a lubricant smoothing device 12, material having a blade form formed polyurethane rubber, silicone rubber, nitrile rubber, chloroprene rubber, etc. can be suitably used.

With regard to the form of the blade, when the blade is in contact with the image bearing member 8 in a counter manner, it is suitable that the edge of the blade contacting with the image bearing member 8 has a top having a blunt angle (90 to 180°). By having such a form, the contact pressure of the blade against the image bearing member 8 increases so that the efficiency of smoothing a lubricant layer is improved.

In addition, the contact of the blade of the lubricant smoothing device 12 against the image bearing member 8 can be in a trailing or counter manner relative to the rotation direction of the image bearing member 8.

A blade used as the lubricant smoothing device 12 can be used in combination with the cleaning device 7. When the lubricant application device 6 is on the downstream side from the cleaning device 7 relative to the rotation direction of the image bearing member 8, the lubricant smoothing device 12 is desired to be provided on the downstream side from the lubricant application device 6 and on the upstream side from the charging device 1 relative to the rotation direction of the image bearing member 8.

In addition, with regard to the image forming apparatus and the image formation device of the present invention, the toner particles of the toner for use in the development of the latent electrostatic image on the image bearing member in the development process or the developing device are preferred to have a ratio A of from 0.3 to 1.7 and preferably from 0.6 to 1.0 and include particulates containing resin particulates and inorganic particulates. Also, it is preferable that the resin particulate P1 having an average primary particle diameter of from 60 to 600 nm is externally added to the toner. Ratio A is obtained by the following relationship (1):

Ratio A=mother toner BET specific surface area/mother toner volume average particle diameter Relationship (1).

When the avearage primary particle diameter of the resin particulate is out of the range mentioned above, the following concern arises. That is, when the avearage primary particle diameter is too small, the spacer function of the resin particulate tends to be lost. On the other hand, when the avearage primary particle diameter is too large, the attachment property to toner tends to deteriorate, meaning that isolated resin particulates tend to cause other problems such as filming on an image bearing member.

As the resin particulates having an average primary particle diameter of from 60 to 600 nm, acryl non-cross-linking type monodispersion resin particles (MP-1451, manufactured by Soken Chemical & Engineering Co., Ltd.) can be used and is actually used in Examples described later. Other suitable resin particulates having an average primary particle diameter of from 60 to 600 nm are: acryl non-cross-linking monodispersion resin particles (MP300, MP2200, MP2701, MP5000, MP5500 and MP4009, all manufactured by Soken Chemical & Engineering Co., Ltd.). In the present invention, the amount of the resin particulates in all the resin particles is generally not less than 50%, preferably not less than 60% and more preferably not less then 90%.

The toner for use in the image forming apparatus and the image forming method of the present invention is preferred to have a volume average particle diameter of from 3.0 to 5.5 μm.

### Particle Diameter Measuring Method

The volume average particle diameter (Dv) and the number average particle diameter (Dn) of toner particles are measured by a particle size measuring device (Multisizer III, manufactured by Beckman Coulter Inc.) with an aperture of 100 μm and the measuring result is analyzed by analysis software (Beckman Coulter Multisizer 3 version 3.51).

Specifically, 0.5 ml of 10 wt % surface active agent (alkylbenzene sulfonate SC-A, manufactured by Daiichi Kogyo Co., Ltd.) is placed in a glass beaker (100 ml). 0.5 g of each toner is added in the beaker and stirred by a microspatula. 80 ml of deionized water is added to the mixture and the thus obtained liquid dispersion is subject to dispersion treatment for 10 minutes by an ultrasonic wave dispersion device (W-113MK-II, manufactured by Honda Electronics).

The toner sample liquid dispersion is measured by the Multisizer III using ISOTONO III (manufactured by Beckman Coulter Inc.) as the measuring solution.

The toner sample liquid dispersion is dropped such that the density indicated by the measuring device is from 6 to 10%. In this measuring method, it is desired to make the density in the range mentioned above in terms of measuring reproducilibty. The measured particle size does not have an error when the density is in that range.

The toner for use in the image forming apparatus and the image forming method of the present invention is preferred that the resin particulates having an average primary particle diameter of from 60 to 600 nm is added to the toner in an amount of from 0.5 to 4.0% by weight. In addition, the ratio (Dv) of the volume average particle diameter (Dv) to the number average particle diameter (Dn) of the toner is preferably from 1.00 to 1.40.

### Particle Size Distribution of Toner Particles

To reproduce fine dots for 60 dpi or higher, the volume average particle diameter of toner particles preferably ranges from 3 to 8 μm.

The ratio (Dv) of the volume average particle diameter (Dv) to the number average particle diameter (Dn) of the toner is preferably from 1.00 to 1.40.

A ratio (Dv/Dn) that is close to 1 represents that the particle size distribution is sharp. The distribution of the amount of charge of a toner having such a small particle diameter with a sharp particle size distribution is uniform so that quality images without fogging can be obtained. In addition, the transfer ratio is improved for the electrostatic transfer system.

The particle diameter of the toner particles for use in the present invention is measured by Coulter Counter method. Specific examples of the devices measuring particle size distribution of toner particles using the Coulter Counter method include Coulter Counter TA-II and Coulter Multisizer II (both are manufactured by Beckman Coulter Inc.). The measuring method is described below.

(1) Add 0.1 to 5 ml of a surface active agent (preferably a salt of an alkyl benzene sulfide) as a dispersant to 100 to 150 ml of an electrolytic aqueous solution. The electrolytic aqueous solution is an about 1% NaCl aqueous solution prepared by using primary NaCl (e.g., ISOTON-II®, manufactured by Beckman Coulter Inc.).

(2) Add 2 to 20 mg of a measuring sample to the electrolytic aqueous solution.

(3) The electrolytic aqueous solution in which the measuring sample is suspended is subject to a dispersion treatment for 1 to 3 minutes with a supersonic disperser.

(4) Measure the volume and the number of the toner particles or the toner to calculate the volume distribution and the number distribution for each particle diameter channel described below while the aperture is set to 100 μm for the measuring device mentioned above.

(5) Calculate the weight average particle diameter (D4) and the number average particle diameter of the toner from the obtained distribution.

The whole range is a particle diameter of from 2.00 to not greater than 40.30 μm and the number of the channels is 13. Each channel is: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm.

The toner for use in the image forming apparatus and the image forming method of the present invention is preferred that particles having a particle diameter of not greater than 2 μm ranges from 1 to 25% by number.

### Method of Measuring Particle Diameter not Greater Than 2 μm

The spherical degree and the ratio of the particle having a particle diameter of not greater than 2 μm can be measured by a flow type particle image analyzer FPIA-2100 (manufactured by SYSMEX CORPORATION).

The specific measuring procedure is as follows:
1) 0.1 to 5 ml of a surface active agent serving as a dispersant, preferably an alkylbenzenesulfonic acid salt, is added to 100 to 150 ml of water from which solid impurities have been removed;
2) 0.1 to 0.5 g of a sample to be measured is added into the mixture prepared in (1);
3) the mixture prepared in (2) is subject to an ultrasonic dispersion treatment for about 1 to about 3 minutes such that the concentration of the particles is 3,000 to 10,000 particles per microlitter; and
4) the form and average particle diameter distribution of the sample are determined using the instrument mentioned above.

The toner for use in the image forming apparatus and the image forming method of the present invention is preferred that the toner includes toner particles having an average circularity of from 0.950 to 0.980.

Also, the toner for use in the image forming apparatus and the image forming method of the present invention is preferred that the toner includes toner particles having a circularity of from 0.97 to 1.0 in an amount of less than 40%.

Method of measuring Average Circularity (Same As Method of Measuring Particle Diameter not Greater Than 2 μm)

The average circularity can be obtained by using a flow type particle image analyzer FPIA-2100 (manufactured by SYSMEX CORPORATION). The specific measuring procedure is as follows:
1) 0.1 to 5 ml of a surface active agent serving as a dispersant, preferably an alkylbenzenesulfonic acid salt, is added to 100 to 150 ml of water from which solid impurities have been removed;
2) 0.1 to 0.5 g of a sample to be measured is added into the mixture prepared in (1);
3) the mixture prepared in (2) is subject to an ultrasonic dispersion treatment for about 1 to about 3 minutes such that the concentration of the particles is 3,000 to 10,000 particles per microlitter; and
4) the form and average particle diameter distribution of the sample are determined using the instrument mentioned above.

The toner for use in the image forming apparatus and the image forming method of the present invention is preferred that the toner includes toner particles including inorganic particulates having an average primary particle diameter of from 1 to 50 nm in an amount of from 0.5 to 4.0% by weight.

The inorganic particulates therein preferably include silicon oxide and/or titanium oxide.

It is preferable to use hydrophobic titanium oxide particulates or hydrophobic aluminum oxide particulates as an environment stabilization imparting agent. Furthermore, it is more preferable to use hydrophobic silica particulates and hydrophobic titanium oxide particulates or hydrophobic aluminum oxide particulates in combination to impart environment stability and fluidity.

It is preferred that the toner for use in the present invention is manufactured by granulation in an aqueous medium and includes a binder resin, a coloring agent, a laminate inorganic mineral in which at least part of ions between metal cation layers is modified by an organic cation.

### Toner Granulated From Aqueous Medium

The toner for use in the present invention can be manufactured by the following method. It is preferable that the toner contains at least laminate inorganic mineral (organic modified clay) having metal cation at least part of which is modified by an organic cation.

Furthermore, it is more preferred with regard to the toner that the solid portion in a solution or a liquid dispersion in which at least a binder resin, a prepolymer formed of a modified polyester resin, a compound which conducts elongation reaction or cross linking reaction with the prepolymer, a coloring agent, a releasing agent, and the laminate inorganic mineral (organic modified clay) in which at least part of ions between metal cation layers are modified by an organic cation are dissolved or dispersed in an organic solvent contains the laminate inorganic mineral (organic modified clay) in which at least part of ions between metal cation layers are modified by an organic cation in an amount of from 0.05 to 10%.

The toner is preferably obtained by dissolving or dispersing at least a binder resin, a prepolymer formed of a modified polyester resin, a compound which conducts elongation reaction or cross linking reaction with the prepolymer, a coloring agent, a releasing agent, and the laminate inorganic mineral (organic modified clay) in an organic solvent, conducting cross-linking reaction and/or elongation reaction in the organic solution or liquid dispersion in an aqueous medium and removing the solvent from the liquid dispersion. In addition, it is preferred that the solution or the liquid dispersion has a Casson yield value of from 1 to 100 Pa at 25° C. A specific toner manufacturing method is described below.

### Laminate Inorganic Mineral in Which At Least Part of Ions Between Metal Cation Layers is Modified by Organic Cation

With regard to the laminate inorganic mineral in which at least part of ions between metal cation layers are modified by an organic cation toner for use in the toner for use in the present invention, it is extremely preferable to use a laminate inorganic mineral in which at least part of ions between metal cation layers are modified by an organic cation which makes the Casson yield value at 25° in the range of from 1 to 100 Pa in a solution or a liquid dispersion in which at least a binder resin, a prepolymer formed of a modified polyester resin, a compound which conducts elongation reaction or cross linking reaction with the prepolymer, a coloring agent, a releasing agent, and the laminate inorganic mineral (organic modified clay) are dissolved or dispersed in an organic solvent. When the Casson yield value is too small, it is difficult to obtain a target form of the toner. When the Casson yield value is too large, the manufacturing property tends to deteriorate. In addition, as described above, the organic modified clay is preferred to be contained in the solid portion of the solution or the liquid dispersion in an amount of from 0.05 to 10%. When the amount is too small, a target Casson yield value is difficult to obtain. When the amount is too large, the fixing property may deteriorate.

As the laminate inorganic mineral in which at least part of ions between metal cation layers are modified by an organic cation, for example, organic modified monmolinite and organic modified smectite are suitably used.

### Method of Measuring Casson Yield Value

Casson yield value can be measured by using a high shear viscosity meter under the following conditions:

Device: AR2000 (manufactured by TA Instruments)

Shear stress: 120 Pa/5 min

Geometry: 40 mm steel plate

Geometry gap: 1 mm

Analysis software: TA DATA ANAYALYSIS (manufactured by TA Instruments)

One example of the toner for use in the image forming apparatus and the image forming method of the present invention is a toner obtained by conducting cross-linking and/or elongation reaction of toner composition liquid in an aqueous medium in which at least a polyester prepolymer having a functional group having a nitrogen atom, a polyester, a coloring agent, and a releasing agent are dispersed in an organic solvent.

The toner composition material and the manufacturing method of the toner are specified in detail below.

### Polyester

Specific examples of the diols (DIO) include alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F and bisphenol S); adducts of the alicyclic diols mentioned above with an alkylene oxide (e.g., ethylene oxide, propylene oxide and butylene oxide); and adducts of the bisphenols mentioned above with an alkylene oxide (e.g., ethylene oxide, propylene oxide and butylene oxide); etc.

Among these compounds, alkylene glycols having from 2 to 12 carbon atoms and adducts of a bisphenol with an alkylene oxide are preferable. More preferably, adducts of a bisphenol with an alkylene oxide, or mixtures of an adduct of a bisphenol with an alkylene oxide and an alkylene glycol having from 2 to 12 carbon atoms are used.

Specific examples of the polyols (TO) include aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide; etc.

Suitable polycarboxylic acids (PC) include dicarboxylic acids (DIC) and polycarboxylic acids (TC) having three or more carboxyl groups. It is preferable to use dicarboxylic acids (DIC) alone or mixtures in which a small amount of a TC is mixed with a DIC.

Specific examples of the dicarboxylic acids (DIC) include alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used.

Specific examples of the polycarboxylic acids (TC) having three or more hydroxyl groups include aromatic polycarboxylic acids having from 9 to 20 carbon atoms (e.g., trimellitic acid and pyromellitic acid).

As the polycarboxylic acid (TC), anhydrides or lower alkyl esters (e.g., methyl esters, ethyl esters or isopropyl esters) of the polycarboxylic acids mentioned above can be used for the reaction with a polyol.

Suitable mixing ratio (i.e., an equivalence ratio [OH]/[COOH]) of a polyol (PO) to a polycarboxylic acid (PC) is from 2/1 to 1/1, preferably from 1.5/1 to 1/1 and more preferably from 1.3/1 to 1.02/1.

The polycondensatoin reaction between the polyol (PO) and the polycarboxylic acid (PC) is conducted by heating the mixture thereof under the presence of a known esterification catalyst such as tetrabuthoxytitanate and dibutyltin oxide to a temperature of from 150 to 280° C. with a reduced pressure, if desired, while removing produced water to obtain a polyester having a hydroxyl value.

The hydroxyl value of the polyester is preferably 5 or higher. When a polyester having such an acid value is used, the produced toner is easily negatively charged and the affinity of the toner and a recording medium is improved during fixing of a toner image on the recording medium.

An acid value that is excessively high has an adverse impact on the stability of chargeability and especially on the environment change.

The weight average molecular weight of the polyester is from 10,000 to 400,000 and preferably from 20,000 to 200,000.

When the weight average molecular weight is too small, the anti-offset property deteriorates. When the weight average molecular weight is too large, the low temperature fixing property deteriorates.

It is preferred to contain a urea-modified polyester in addition to the polyester obtained from the polycondensation reaction described above. Such a urea-modified polyester is obtained by reacting the carboxyl group or hydroxyl group at the end of the polyester obtained from the polycondensation reaction described above with a polyisocyanate compound (PIC) to obtain a polyester prepolymer (A) having an isocyanate group followed by cross-linking reaction and/or elongation reaction with an amine to cross-link or elongate the molecule chain.

Specific examples of the polyisocyanates (PIC) include aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic didicosycantes (e.g., tolylene diisocyanate and diphenylmethane diisocyanate); aromatic aliphatic diisocyanates (e.g., α, α, α′, α′-tetramethyl xylylene diisocyanate); isocyanurates; blocked polyisocyanates in which the polyisocyanates mentioned above are blocked with phenol derivatives, oximes or caprolactams; etc. These compounds can be used alone or in combination.

Suitable mixing ratio (i.e., [NCO]/[OH]) of a polyisocyanate (PIC) to a polyester having a hydroxyl group is from 5/1 to 1/1, preferably from 4/1 to 1.2/1 and more preferably from 2.5/1 to 1.5/1. When the [NCO]/[OH] ratio is too large, the low temperature fixability of the toner deteriorates. When the molar ratio of [NCO] is too small and a urea modified polyester is used, the content of urea in the ester tends to be small, which degrades the anti-offset property.

The content of the constitutional component of a polyisocyanate (PIC) in the polyester prepolymer (A) having a polyisocyanate group at its end portion is from 0.5 to 40% by weight, preferably from 1 to 30% by weight and more preferably from 2 to 20% by weight. When the content is too low, the hot offset resistance of the toner deteriorates and in addition the heat resistance and low temperature fixability of the toner also deteriorate. In contrast, when the content is too high, the low temperature fixability of the toner deteriorates.

The number of isocyanate groups included in the prepolymer (A) per molecule is normally not less than 1, preferably from 1.5 to 3, and more preferably from 1.8 to 2.5. When the number of isocyanate groups is too small, the molecular weight of the urea-modified polyester tends to be low, which degrades the anti-hot offset property.

Specific examples of the amines (B) to react with the prepolymer (A) include, but are not limited to, diamines (B1), polyamines (B2) having three or more amino groups, amino alcohols (B3), amino mercaptans (B4), amino acids (B5), and blocked amines (B6), in which the amines (B1-B5) mentioned above are blocked.

Specific examples of the diamines (B1) include, but are not limited to, aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc.

Specific examples of the polyamines (B2) having three or more amino groups include, but are not limited to, diethylene triamine, triethylene and tetramine. Specific examples of the amino alcohols (B3) include, but are not limited to, ethanol amine and hydroxyethyl aniline. Specific examples of the amino mercaptan (B4) include, but are not limited to, aminoethyl mercaptan and aminopropyl mercaptan. Specific examples of the amino acids (B5) include amino propionic acid and amino caproic acid. Specific examples of the blocked amines (B6) include, but are not limited to, ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine (B1) is mixed with a small amount of a polyamine (B2) are preferable.

The mixing ratio of the amines (B) to the prepolymer (A), i.e., the equivalent ratio ([NCO]/[NHₓ]) of the isocyanate group [NCO] contained in the prepolymer (A) to the amino group [NHₓ] contained in the amines (B), is normally from 1/2 to 2/1, preferably from 1.5/1 to 1/1.5 and more preferably from 1.2/1 to 1/1.2. When the mixing ratio is too large or too small, the molecular weight of the resultant urea-modified polyester (i) decreases, resulting in deterioration of the hot offset resistance of the resultant toner.

The modified polyesters can include a urethane linkage as well as a urea linkage. The molar ratio (urea/urethane) of the urea linkage to the urethane linkage may vary from 100/0 to 10/90, preferably from 80/20 to 20/80 and more preferably from 60/40 to 30/70. When the content of the urea linkage is too low, the hot offset resistance of the resultant toner deteriorates.

A polyester having a hydroxyl value urea-modified polyester is manufactured by one shot method. A polyester having a hydroxyl value is obtained by heating a polyol (PO) and a polycarboxylic acid (PC) under the presence of a known esterification catalyst such as tetrabuthoxytitanate and dibutyltin oxide to a temperature of from 150 to 280° C. with a reduced pressure, if desired, while removing produced water. Thereafter, the polyester is reacted with a polyisocyanate (PIC) at 40 to 140° C. to obtain a polyester prepolymer (A) having an isocyanate group. Furthermore, an amine (B) is reacted with the polyester prepolymer at 0 to 140° C. to obtain a urea-modified polyester.

When the polyisocyanate (PIC) is reacted and the polyester prepolymer (A) and the amine (B) are reacted, a solvent can be used, if desired. Specific examples thereof include, but are not limited to, aromatic solvents (e.g., toluene and xylene), ketones (e.g., acetone, methylethylketone and methylitobutyl ketone), esters (e.g., ethyl acetate), amides (e.g., dimethylformamide and dimethylacetamide), and ethers (e.g., tetrahydrofuran), which are inactive with a polyisocyanate (PIC).

During the cross-linking reaction and/or elongation reaction between the polyester prepolymer (A) and the amine (B), The molecular weight of the urea-modified polyesters can be controlled using a molecular-weight control agent, if desired. Specific examples of the molecular-weight control agent include, but are not limited to, monoamines (e.g., diethyl amine, dibutyl amine, butyl amine and lauryl amine), and blocked amines (i.e., ketimine compounds) prepared by blocking the monoamines mentioned above.

The weight average molecular weight of the urea-modified polyesters is not less than 10,000, preferably from 20,000 to 10,000,000 and more preferably from 30,000 to 1,000,000. When the peak molecular weight is too small, the hot offset resistance (anti-hot offset property) tends to deteriorate. The number average molecular weight of the urea-modified polyesters is not particularly limited when the unmodified polyester resin is used in combination. Namely, controlling of the weight average molecular weight of the modified polyester resins has priority over controlling of the number average molecular weight thereof.

When a urea-modified polyester is used alone, the number average molecular weight thereof is from 2,000 to 15,000, preferably from 2,000 to 10,000 and more preferably from 2,000 to 8,000. When the number average molecular weight is too large, the low temperature fixability of the resultant toner deteriorates, and in addition the gloss of full color images decreases when the toner is used in a full color image forming apparatus.

By using a non-modified polyester and a urea-modified polyester in combination, the low temperature fixability and gloss level is improved when used in a full color image developing machine and is therefore preferable to the single use of the urea-modified polyester alone. The non-modified polyester can contain a polyester modified by a chemical linkage other than the urea linkage.

It is preferable that the urea-modified polyester and the non-modified polyester are at least partially compatible with each other to improve the low temperature fixability and hot offset resistance properties. Therefore, it is preferable, but not mandatory, that the polyester component in the urea-modified polyester has a similar composition to that of the non-modified polyester. The weight ratio of the urea-modified polyester/the non-modified polyester is normally from 5/95 to 80/20, preferably from 5/95 to 30/70, more preferably from 5/95 to 25/75 and even more preferably from 7/93 to 20/80. When the content of the urea-modified polyester is too small, the hot offset resistance of the toner tends to deteriorate and in addition it is difficult to have a good combination of the high temperature preservability and low temperature fixability.

The binder resin having he non-modified polyester and the urea-modified polyester has a glass transition temperature (Tg) of from 45 to 65° C., and preferably from 45 to 60° C. When the glass transition temperature is too low, the high temperature preservability of the toner tends to deteriorate. Bn contrast, when the glass transition temperature is too high, the low temperature fixability easily deteriorates.

In addition, since a urea-modified polyester tends to exist on the surface of the obtained mother toner particle, the glass transition temperature of a toner having such a urea-modified polyester has a good high temperature preservability although the glass transition temperature thereof is relatively low in comparison with that of a known polyester based toner.

### Coloring Agent

Suitable coloring agents for use in the toner for use in the present invention include known dyes and pigments.

Specific examples of the coloring agents include carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

The content of the coloring agent in the toner is preferably from 1 to 15% by weight, and more preferably from 3 to 10% by weight, based on the total weight of the toner.

The coloring agent can be used as a master batch prepared in combination with a binder resin.

Specific examples of the resins for use in the master batch pigments or for use in combination with master batch pigments include, but are not limited to, styrene polymers and substituted styrene polymers such as polystyrene, poly-p-chlorostyrene and polyvinyltoluene; copolymers thereof with a vinyl compound; polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins can be used alone or in combination.

### Charge Control Agent

Any known charge controlling agent can be used. Specific examples thereof include nigrosine dyes, triphenylmethane dyes, chrome containing metal complex dyes, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, metal salts of salicylic acid derivatives, etc. Specific examples thereof include BONTRON 03 (nigrosine dye), BONTRON P-51 (quaternary ammonium salt), BONTRON S-34 (metal containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE PR (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group, for example, sulfonic acid group, carboxyl group, quaternary ammonium group, etc.

The content of the charge control agent is determined depending on the kind of the binder resin used, whether or not an additive is added, and the toner manufacturing method including the dispersion method. For example, the content of the charge control agent is preferably from 0.1 to 10 parts by weight, and more preferably from 0.2 to 5 parts by weight based on 100 parts by weight of the binder resin included in the toner. When the content is too large, the toner tends to have too large chargeability, which leads to reduction in the effect of a main charge control agent, and thereby the electrostatic force with a developing roller increases, resulting in deterioration of the fluidity of the toner and a decrease of the image density of toner images.

### Releasing Agent

It is preferred to use a wax having a low melting point, i.e., from 50° C. to 120° C. since waxes having a low melting point effectively function between a fixing roller and the surface boundary of toner when dispersed with the resin. Therefore, such a wax having a low melting point has a good anti-hot offset property even for an oil-free fixing, in which a wax such as oil is not applied to a fixing roller.

Specific examples of such waxes include natural waxes such as plant waxes such as carnauba wax, cotton wax, haze wax, and rice wax, animal waxes such as yellow bees wax and lanoline, mineral waxes such as ozokerite and petroleum waxes such as paraffin, microcrystalline wax and petrolatum. Other than these natural waxes, synthetic hydrocarbon waxes such as Fisher-Tropsch wax and polyethylene wax, and synthetic waxes such as esters, ketones, and ethers can be used. Further, fatty acid amides such as 1,2-hydroxystearic acid amide, stearic acid amides, anhydrous phthalic acid imides and chlorinated hydrocarbons, homo polymers or copolymers (e.g., copolymers of n-staryl acrylate-ethylmethacrylate) of a polyacrylate, which is a crystalline polymer resin having a relatively low molecular weight, such as poly-n-stearyl methacrylate and poly-n-lauric methacrylate, and crystalline polymers having a long chain alkyl group on its branched chain can be also used.

The charge control agent and the releasing agent can be melted, mixed and kneaded with a master batch and/or a binder resin and can be added when dissolved or dispersed in an organic solvent.

Method of Manufacturing Toner Granulated from Aqueous Medium

Next, the method of manufacturing the toner for use in the present invention is described below specifically but is not limited thereto.

### (a) Prepare Toner Composition Liquid by Dispersing Coloring Agent, Non-modified Polyester, Polyester Prepolymer Having Isocyanate Group, and Releasing Agent in Organic Solvent

The organic solvent is preferred to be volatile and have a boiling point lower than 100° since it is easy to get removed. Specific examples thereof include non-water soluble solvents, for example, aqueous toluene, xylene, benzene, carbon tetrachloride, methylene chloride, 1,2-dichloroethane, 1,1,2-trichloroethane, trichloroethylene, chloroform, monochlorobenzene, methyl acetate and ethyl acetate, methylethyl ketone and methylisobuthyl ketone. These can be used alone or in combination. Especially, aromatic hydrocarbons, for example, toluene and xylene, and halogenated hydrocarbons, for example, methylene chloride, 1,2-dichloroethane, chloroform and carbon tetrachloride, are preferred.

The content of the organic solvent is from 0 to 300 parts by weight, preferably from 0 to 100 parts by weight and more preferably from 25 to 70 parts by weight based on 100 parts by weight of prepolymer

### (b) Emulsifying Toner Composition Liquid in Aqueous Medium Under Presence of Surface Active Agent and Resin Particulate

Suitable aqueous media for use in the present invention include water, and mixtures of water with a solvent which can be mixed with water. Specific examples of such a solvent include alcohols (e.g., methanol, isopropanol and ethylene glycol), dimethylformamide, tetrahydrofuran, cellosolves (e.g., methyl cellosolve), lower ketones (e.g., acetone and methyl ethyl ketone), etc.

The content of the aqueous medium is from 50 to 2,000 parts by weight and more preferably from 100 to 1,000 parts by weight based on 100 parts of the toner composition liquid. When the content is too small, the dispersion status in the toner composition liquid tends to be insufficient so that toner particles having a target particle diameter are not obtained. A content that is too large is not suitable in terms of the economy.

In addition, to make the dispersion in the aqueous medium better, a dispersant such as a surface active agent and a resin particulate can be added.

Specific examples of the surface active agents (dispersants) which are used for dispersing or emulsifying an oil phase in which toner constituents are dissolved or dispersed in an aqueous liquid, include, but are not limited to, anionic surface active agents such as alkylbenzene sulfonic acid salts, α-olefin sulfonic acid salts, and phosphoric acid salts; cationic surface active agents such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surface active agents such as fatty acid amide derivatives, polyhydric alcohol derivatives; and ampholytic surface active agents such as alanine, dodecyldi(aminoethyl)glycin, di(octylaminoethyle)glycin, and N-alkyl-N,N-dimethylammonium betaine.

A surface active agent having a fluoroalkyl group is effective in an extremely small amount. Specific preferred examples of anionic surface active agents having a fluoroalkyl group include, but are not limited to, fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4)sulfonate, sodium 3-{omega-fluoroalkanoyl(C6-C8)-N-ethylamino}-1-propanesulfonate, fluoroalkyl(C11-C20)carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such surface active agents having a fluoroalkyl group include, but are not limited to, SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of the cationic surface active agents, which can be used for dispersing an oil phase including toner constituents in water, include primary, secondary and tertiary aliphatic amines having a fluoroalkyl group, aliphatic quaternary ammonium salts such as perf luoroalkyl (C6-C10) sulfoneamidepropyltrimethylammonium salts, benzalkonium salts, benzetonium chloride, pyridinium salts, imidazolinium salts, etc. Specific examples of the marketed products thereof include SURFLON S-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

Specific examples of the resin particulates include, but are not limited to, particulate polymethyl methacylate (MMA) having a particle diameter of 1 and 3 μm, particulate polystyrene having a particle diameter of 0.5 and 2 μm, particulate styrene-acrylonitrile copolymers having a particle diameter of 1 μm, etc. Specific examples of the marketed resin particulates include, but are not limited to, PB-200H (available from Kao Corp.), SGP (available from Soken Chemical & Engineering Co., Ltd.), TECHNOPOLYMER® SB (available from Sekisui Plastics Co., Ltd.), SPG-3G (available from Soken Chemical & Engineering Co., Ltd.), MICROPEARL® (available from Sekisui Fine Chemical Co., Ltd.), etc.

In addition, inorganic dispersing agents can be used. Specific examples thereof include, but are not limited to, tricalcium phosphate, calcium carbonate, titanium oxide, colloidal silica and hydroxyapatite.

Furthermore, it is possible to stably disperse toner components in an aqueous medium using a polymeric protection colloid in combinational use with the inorganic dispersing agents and particulate polymers mentioned above. Specific examples of such protection colloids include, but are not limited to, polymers and copolymers prepared using monomers, for example, acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g., acrylamide, methacrylamide and diacetoneacrylamide) and their methylol compounds, acid chlorides (e.g., acrylic acid chloride and methacrylic acid chloride), and homopolymers or copolymers having a nitrogen atom or an alicyclic ring having a nitrogen atom (e.g., vinyl pyridine, vinyl pyrrolidone, vinyl imidazole and ethylene imine).

In addition, polymers, for example, polyoxyethylene based compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters), and cellulose compounds, for example, methyl cellulose, hydroxyethyl cellulose and hydroxypropyl cellulose, can also be used as the polymeric protective colloid.

The dispersion method is not particularly limited, and low speed shearing methods, high speed shearing methods, friction methods, high pressure jet methods, ultrasonic methods, etc. can be used. Among these methods, high speed shearing methods are preferable because particles having a particle diameter of from 2 to 20 μm can be easily prepared. At this point, the particle diameter (2 to 20 μm) means a particle diameter of particles including a liquid.

When a high speed shearing type dispersion machine is used, the rotation speed is not particularly limited, but the rotation speed is typically from 1,000 to 30,000 rpm, and preferably from 5,000 to 20,000 rpm. The dispersion time is not particularly limited, but is typically from 0.1 to 5 minutes. The temperature in the dispersion process is typically from 0 to 150° C. (under pressure), and preferably from 40 to 98° C.

### (c) Add Amine (B) During Preparation of Emulsion to React With Polyester Prepolymer (A) Having Isocyanate Group

In this reaction, molecule chains are cross-linked and/or elongated.

The cross-linking time and/or the elongation time is determined depending on the reactivity determined by the combination of the structure of the isocyanate group in a prepolymer (A) and an amine (B). The cross-linking time and/or the elongation time is in general from 10 minutes to 40 hours, and preferably from 2 to 24 hours. The reaction temperature is generally from 0 to 150° C., and preferably from 40 to 98° C. In addition, a known catalyst can be optionally used. Specific examples of such elongation agents and/or cross-linking agents include, but are not limited to, dibutyltin laurate and dioctyltin laurate.

(d) Obtaining Mother Toner Particle by Removing Organic Solvent from Emulsion Dispersion (Reactant) Followed by Washing and Drying After Reaction Described Above

To remove the organic solvent, the whole system is gradually heated while agitated under laminar flow conditions. Then the system is strongly agitated in a certain temperature range, followed by solvent removal, to prepare a mother toner having a spindle form.

When compounds such as calcium phosphate which are soluble in an acid or alkali are used as a dispersion stabilizer, it is preferable to dissolve calcium phosphate by adding an acid such as hydrochloric acid and to wash the resultant particles with water to remove calcium phosphate therefrom. In addition, such a dispersion stabilizer can be removed using a decomposition method using an enzyme.

Below are the descriptions about the measuring method for each item.

Particle Diameter not Greater than 2 μm

The spherical degree and the ratio of the particle having a particle diameter of not greater than 2 μm of the toner for use in the present invention can be measured by a flow type particle image analyzer FPIA-2100 (manufactured by SYSMEX CORPORATION).

The specific measuring procedure is as follows:
1) 0.1 to 5 ml of a surface active agent serving as a dispersant, preferably an alkylbenzenesulfonic acid salt, is added to 100 to 150 ml of water from which solid impurities have been removed;
2) 0.1 to 0.5 g of a sample to be measured is added into the mixture prepared in (1);
3) the mixture prepared in (2) is subject to an ultrasonic dispersion treatment for about 1 to about 3 minutes such that the concentration of the particles is 3,000 to 10,000 particles per microlitter; and
4) the form and average particle diameter distribution of the sample are determined using the instrument mentioned above.

### Molecular Weight

The molecular weight can be measured by gel permeation chromatography (GPC) as follows: Stabilize a column in a heat chamber at 40° C.; Flow tetrahydrofuran (THF) at this temperature at 1 ml/min as a column solvent; Fill 50 to 200 μl of a tetrahydrofuran sample solution of a resin which is prepared to have a sample density of 0.05 to 0.6 weight % for measurement. The molecular weight distribution of the sample is calculated by comparing the logarithm values and the count values of the analytical curves obtained from several kinds of single dispersion polystyrene standard sample. Specific examples of the standard polystyrene samples for the analytical curves include polystyrenes having a molecular weight of 6×102, 2.1×103, 4×103, 1.75×104, 5.1×104, 1.1×105, 3.9×105, 8.6×105, 2×106 and 4.48 ×106, manufactured by Pressure Chemical Co., or Tosoh Corporation. It is preferred to use at least about ten standard polystyrene samples. A refractive index (RI) detector can be used as the detector.

### Acid Value

The acid value is measured according to the measuring method described in JIS K0070-1992.

Sample adjustment: 0.5 g of polyester (0.3 g with regard to the composition soluble in ethyl acetate) is added to 120 ml of toluene and the mixture is stirred at room temperature (23° C.) for about 10 hours to dissolve the polyester. 30 ml of ethanol is added thereto to prepare a sample solution.

The acid value can be measured by the device described in JIS K0070-1992 and calculated specifically as follows:

Preliminarily standardizationed N/10 caustic potash—alcohol solution is used for titration and the acid is calculated from the consumption amount of the caustic potash—alcohol solution using the following relationship:

Acid value=KOH (ml)×N×56.1/(weight of sample material), where N represents the factor in N/10 KOH

### Hydroxyl Value

Precisely weigh 0.5 go of a sample in a 100 ml flask and add 5 ml of acetylation reagent. Thereafter, heat the mixture in a bath at 95 to 105° C. After one or two hours, take out the flask from the bath and leave the flask to cooling down. Add water and shake the flask to decompose acetic anhydride. To completely decompose acetic anhydride, bathe the flask in a bath again to heat the system for at least 10 minutes. After leaving the flask to cooling down, wash the wall of the flask with an organic solution. Perform potentiometric titration of the resultant liquid with N/2 potassium hydroxide ethylalcohol solution using the electrode to obtain the hydroxyl (OH) value (according to JIS K0070-1996).

### Glass Transition Temperature (Tg)

The glass transition temperature can be measured by the following method in which, for example, TG-DSC system TAS-100 (manufactured by Rigaku Corporation) is used: Place about 10 mg of a toner in a sample container made of aluminum; Place the sample container on a holder unit; Set the holder unit in an electric furnace; Heat the electric furnace from room temperature to 150° C. at a temperature rising speed of 10° C./min; Leave it at 150° C. for 10 minutes; Cool dwon the sample to room temperature and leave it for 10 minutes; Thereafter, heat the sample to 150° C. at a temperature descending speed of 10° C./min; Measure the DSC curve by a differential scanning calorimeter (DSC); and, from the obtained DSC curve, calculate the glass transition temperature (Tg) from the intersection point of a tangent of the endothermic curve around the glass transition temperature (Tg) and the base line using the analysis system installed in TAS-100 system.

### Image Forming Apparatus

An image forming apparatus having the following characteristics is suitable as the image forming apparatus described above for the present invention.

Below is a continuing description about the image forming apparatus and the image forming method described above as an example of the image forming apparatus and the image forming method of the present invention. As illustrated in FIG. 3, the lubricant application device and the lubricant application process are preferred to be provided on the downstream side from the cleaning device 7 and the cleaning process and on the upstream side from the charging device 1 and the charging process relative to the rotation direction of the image bearing member 8.

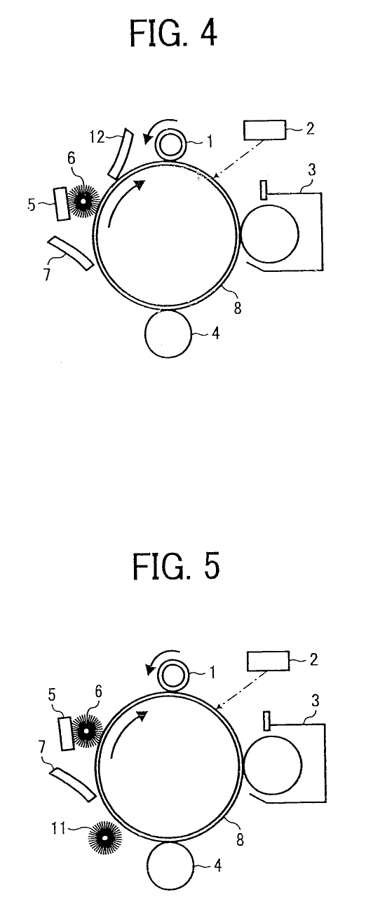

When the lubricant smoothing device 12 is provided, it is preferred that the lubricant smoothing device 12 is provided on the downstream side of the lubricant application device 6 and on the upstream side from the charging device 1 relative to the rotation direction of the image bearing member 8 as illustrated in FIG. 4.

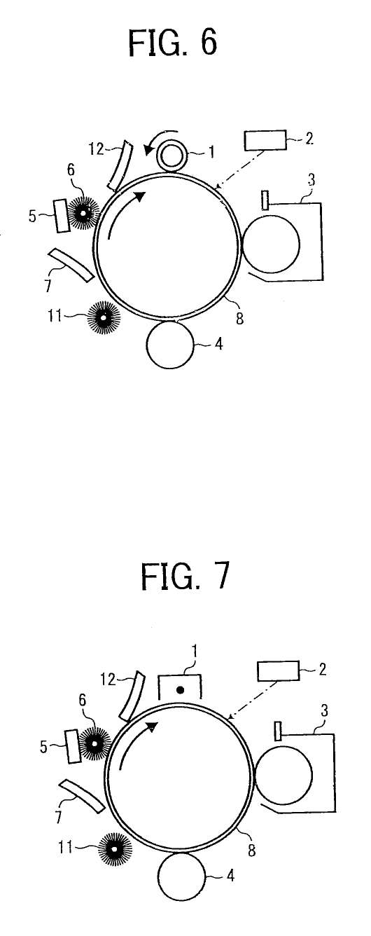

It is also possible to employ other configurations illustrated in FIGS. 5 and 6.

Furthermore, the charging device 1 can be the contact type charging device as illustrated in FIGS. 4, 5 and 6 and the vicinity type charging device as illustrated in FIG. 7. In addition, a charging system using corona discharging can be employed and is preferred to avoid the problems such as the abrasion and physical contact described above.

The image forming apparatus of the present invention is preferred to control removing discharge products on the surface of the image bearing member when a continuous printing number of an image pattern having an image area ratio (for example, 5%) of not greater than a predetermined ratio reaches a particular number. In addition, the image forming apparatus and the image forming method of the present invention are preferred to control and perform toner spitting by a toner spitting control device to supply the toner in a predetermined amount from the developing device when a continuous printing number of an image pattern having an image area ratio of not greater than a predetermined ratio reaches a particular number.

The control process of removing a discharge product is as follows.

first, rotate an image bearing member at an arbitrary rotation speed;

thereafter perform development with toner;

enter the toner into a cleaning device without transfer;

rotate the image bearing member for a certain time; and

discharge the toner by a toner discharging device sequentially.

Therefore, a discharge product attached to the surface of the image bearing member is removed together by the toner by the cleaning device.

In this process, it does not matter whether optical writing has been performed or the image bearing member is charged by a charging device. In addition, the the amount of the toner for use in this process is not limited but an amount that is excessively large is burden for the cleaning process and accelerates abrasion of the cleaning device. Therefore, the amount of the toner is preferably from 0.1 to 0.3 mg/cm² and about 600 cm² with regard to the area.

A discharge product removing device is preferably used when removing a discharge product.

Furthermore, the image forming apparatus is preferred to have an image bearing member having a surface layer in which a filler is dispersed.

Furthermore, the image forming apparatus is preferred to have an organic photoreceptor having a surface layer which is reinforced by a filler as the image bearing member 8. Thereby, the working life of the image bearing member 8 is extended. In addition, by using the image bearing member 8 having a good anti-abrasion property, it is easy to keep the surface of the image bearing member 8 flat. Therefore, the toner is not trapped in the irregularity on the surface of the image bearing member 8 so that the cleaning property is easily maintained.

Organic Photoreceptor Having Surface Layer in which Filler is Dispersed

This is a photoreceptor in which a filler is added to the surface layer functioning as a protective layer to improve the anti-abrasion property. Organic and inorganic fillers can be used in the protective layer. Suitable organic fillers include, but are not limited to, powders of fluorine-containing resins such as polytetrafluoroethylene, silicone resin powders, amorphous carbon powders, etc. Specific examples of the inorganic fillers include, but are not limited to, powders of metals such as copper, tin, aluminum and indium; metal oxides such as alumina, silica, tin oxide, zinc oxide, titanium oxide, alumina, zirconia, indium oxide, antimony oxide, bismuth oxide, calcium oxide, tin oxide doped with antimony, indium oxide doped with tin; potassium titanate, etc. These fillers can be singly used or in combination. The filler is preferred to have an average particle diameter of 0.5 μm or smaller and preferably 0.2 μm or smaller in terms of the transmission factor of a protective layer. In addition, a plasticizer and a leveling agent can be added to the protective layer in the present invention.

Image Bearing Member (Organic Photoreceptor) using Cross-Linking Type Charge Transport Material

The image bearing member 8 of the image forming apparatus of the present invention is preferably an organic photoreceptor using a cross-linking charge type transport material. Thereby, the working life of the image bearing member 8 is extended.

In addition, by using the image bearing member 8 having a good anti-abrasion property, it is easy to keep the surface of the image bearing member 8 flat. Therefore, the toner is not trapped in the irregularity on the surface of the image bearing member 8 so that the cleaning property is easily maintained.

It is more preferred to use an organic photoreceptor having a surface layer which is reinforced by a filler and using a cross-linking type charge transport material.

Below is the description about the image bearing member having a cross-linking structure.

### Cross-Linking Type Protective Layer

A protective layer having a cross-linking structure is preferably used as the binder structure of the protective layer. In the formation of such a cross-linking structure, one or more reactive monomers having multiple cross-linking functional groups in one molecular are used to perform a cross-linking reaction with optical or thermal energy, resulting in formation of three-dimensional mesh structure. This mesh structure has a binding function and a high anti-abrasion property. In terms of the electric stability, anti-abrasion, and working life, it is extremely effective to use only or partially a monomer having a charge transport function as the reactive monomer mentioned above. By using such a monomer, the charge transport portion is formed in the mesh structure so that the function of a protective layer is fully exercised.

As the reactive monomer having a charge transport function, there can be used a compound having at least a charge transport component and at least one silicon atom having a hydrolyzable substituent in the same molecule, a compound having a charge transport component and a hydroxyl group in the same molecule, a compound having a charge transport component and a carboxyl group in the same molecule, a compound having a charge transport component and an epoxy group in the same molecule, and a compound having a charge transport component and an isocyanate group in the same molecule. These charge transport materials having a reactive group can be used alone or in combination. More preferably, a reactive monomer having a triaryl amine structure is effectively used in terms that the reactive monomer is highly electrically and chemically stable and has a high carrier mobility.

In addition, a polymerizable monomer or oligomer having one or two functional groups can be used in combination therewith to control the viscosity during coating, relax the internal stress within a cross-linking type charge transport layer, reduce the surface energy, decrease the friction index, etc. Known radical polymerizable monomers and oligomers can be used.

Additionally, in the cross-linking type charge transport layer, a positive-hole transport compound is polymerized or cross-linked using thermal or optical energy. When the polymerization reaction is performed only by thermal energy, a polymerization initiator is required in some cases. To effectively proceed the reaction at a low temperature, it is suitable to add a polymerization initiator. When the polymerization reaction is performed by light energy, UV is preferred. However, it is rare that the polymerization proceeds only by light energy. Therefore, an optical polymerization initiator is used in combination in general. The polymerization initiator in this case is a compound which absorbs UV having a wavelength of 400 nm or lower to generate active species such as radicals and ions, which start polymerization. In the present invention, the thermal and optical polymerization initiators can be used in combination.

The charge transport layer having a three dimensional network (mesh) structure formed as described above has an excellent anti-abrasion property but significantly contracts in volume during cross-linking reaction, which may result in cracking when a charge transport layer that is excessively thick is formed. It is possible to avoid such a defect by a protective layer having a laminate structure formed of a bottom layer (on the photoreceptor side) in which a low molecular weight compound is dispersed and a top layer (on the surface side) having a cross-linking structure.

### Mother Photoreceptor

The method of manufacturing mother photoreceptor for the image bearing member using the cross-linking type protective layer described above is described.

Liquid applications for undercoating layer, charge generating layer, charge transport layer having the following recipe are sequentially applied on an aluminum cylinder by a dip coating method followed by drying to obtain an undercoating layer having a thickness of 3.5 μm, a charge generating layer having a thickness of 0.2 μm and a charge transport layer having a thickness of 23 μm.

Liquid Application For Undercoating Layer

| | |
|---|---|
| Titanium Dioxide Powder | 400 parts |
| Melamine resin | 65 parts |
| Alkyd resin | 120 parts |
| 2-butanone | 400 parts |

Liquid Application For Charge Generating Layer

| | | |
|---|---|---|
| Polyvinyl butyral | 5 | parts |
| Bisazo pigment having the following chemical structure | 12 | parts |
| 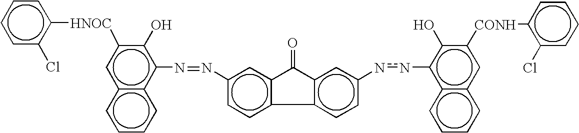 | | |

Liquid Application For Charge Transport Layer

| | | |
|---|---|---|
| Polycarbonate (Z Polica, manufactured by | 10 | parts |
| Teijin Chemicals, Ltd.) | | |
| Charge transport material (Ip: 5.4 ev) | 10 | parts |
| having the following chemical structure | | |
| 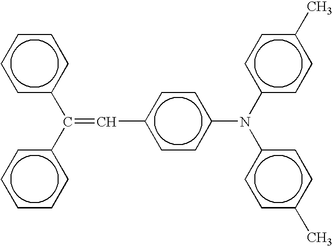 | | |
| Tetrahydrofuran | 100 | parts |

### Image Bearing Member A

Image bearing member A is manufactured by forming a protective layer on the mother photoreceptor described above using liquid application for the protective layer under the following conditions for the layer thickness and manufacturing.

The following recipe is mixed to prepare liquid application for the protective layer. The liquid application is applied to the charge transport layer followed by drying and heating and curing at 110° C. for 1 hour to obtain a protective layer having a thickness of 3 μm.

Recipe

| | | |
|---|---|---|
| Methyltrimethoxysilane | 182 | parts |
| Dihydroxymethyl triphenylamine | 40 | parts |
| 2-propanol | 225 | parts |
| 2% acetic acid | 106 | parts |
| Aluminum trisacetylacetonato | 1 | part |

### Image Bearing Member B

Image bearing member B is manufactured in the same manner as in manufacturing image bearing member A except that the liquid application for the protective layer and the conditions for the layer thickness and the manufacturing are changed to the following.

30 parts of a positive hole transport compound having the following chemical formula 1, 30 parts of acryl monomer having the following chemical formula 2 and 0.6 parts of an optical polymerization initiator (1-hydroxy-cyclohexyl-phenyl-ketone) are dissolved in a solvent mixture of 50 parts of monochlorobenzene and 50 parts of dichloromethane to prepare liquid application for a surface protective layer. This liquid application is applied to the charge transport layer by a spray coating method followed by curing for 30 seconds with light having a light intensity of 500 mW/cm² using a metal halide lamp to form a surface protective layer having a layer thickness of 5 μm.

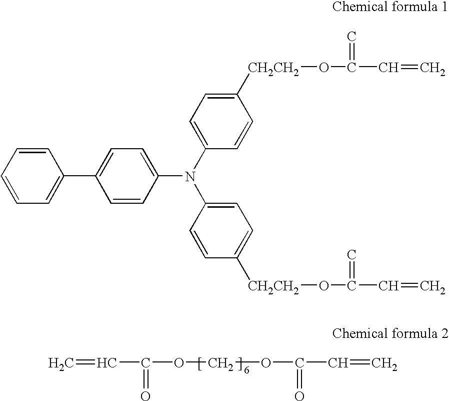

### Amorphous Silicon Photoreceptor (Image Bearing Member)

The image bearing member (photoreceptor) of the image forming apparatus of the present invention is preferably formed of amorphous silicon. Thereby, when an organic photoreceptor having a surface reinforced by dispersing a filler therein is used, the working life of the image bearing member is extended more. In addition, by using an image bearing member having an improved anti-abrasion property, the surface of the image bearing member is easily kept flat. Therefore, the toner is not trapped in the irregularity on the surface of the image bearing member so that the cleaning property is easily maintained.

As the amorphous silicon elctrophotographic photoreceptor, there can be used an amorphous silicon photoreceptor (hereinafter referred to as an a-Si photoreceptor) manufactured by heating an electroconductive substrate to 50 to 400° C. and forming a photoconductive layer of amorphous silicon on the electroconductive substrate by a layer forming method such as a vacuum evaporation method, an ion-plating method, a sputtering method, a thermal CVD method, an optical CVD method and a plasma CVD method. Among these methods, it is suitable to use the plasma CVD method, in which material gas is decomposed by direct current, high frequency or microwave glow discharging to form an amorphous silicon accumulation layer on the electroconductive substrate of an image bearing member.

### Layer Structure of Amorphous Silicon Photoreceptor

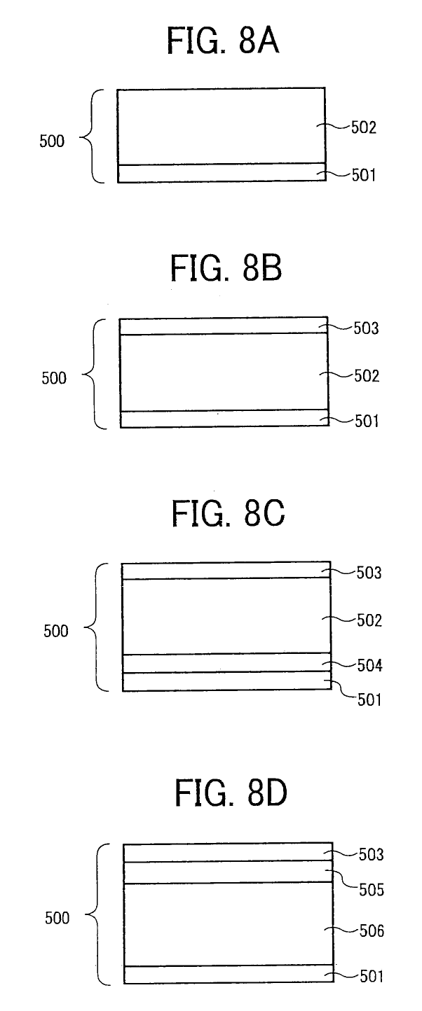

The layer structure of the amorphous silicon photoreceptor is, for example, as follows: FIG. 8 is a schematic diagram illustrating a layer structure for description. With regard to a photoreceptor 500 illustrated in FIG. 8A, a photoconductive layer 502 (or photosensitive layer) formed of a-Si:H,X is provided on a substrate 501. With regard to the photoreceptor 500 illustrated in FIG. 8B, the photoconductive layer 502 (or photosensitive layer) formed of a-Si: H, X and an amorphous silicon based surface layer 503 are provided on the substrate 501. With regard to the photoreceptor 500 illustrated in FIG. 8C, the photoconductive layer (or photosensitive layer) 502 formed of a-Si:H,X, anamorphous silicon based surface layer 503 and an amorphous silicon based charge infusion prevention layer 504 are provided on the substrate 501. With regard to the photoreceptor 500 illustrated in FIG. 8D, a photoconductive layer is provided on the substrate 501. The photoconductive layer is formed of a charge generating layer 505 formed of a-Si:H,X and a charge transport layer 506 and the amorphous silicon based surface layer 503 is formed thereon.

### Substrate

The substrate for a photoreceptor can be electroconductive or insulative. Specific examples of the materials for the electroconductive substrate include, but are not limited to, metals such as Al, Cr, Mo, Au, In, Nb, Te, V, Ti, Pt, Pd and Fe and alloys thereof, for example, stainless steel. It is possible to use an insulative substrate formed of film or sheet made of a synthesis resin such as polyester, polyethylene, polycarbonate, cellulose acetate, polypropylene, polyvinyl chloride, polystyrene and polyamide, glass or ceramic when at least the surface side of the insulative substrate forming the photosensitive layer is electroconductively treated.

The substrate can have a cylinder, board or endless belt form having a smooth or rough surface. The thickness of the substrate can be suitably determined to form a target photoreceptor. When the photoreceptor is required to be flexible, the substrate can be made as thin as possible as long as it can properly function. However, the substrate usually has a thickness of at least 10 μm in terms of manufacturing, handling and mechanical strength.

### Charge Infusion Prevention Layer

It is suitable that the amorphous silicon photoreceptor for use in the present invention has a charge infusion prevention layer 504 between the electroconductive substrate 501 and the photoconductive layer 502 to prevent infusion of charge from the electroconductive substrate 501 as illustrated in FIG. 8C. The charge infusion prevention layer 504 has a function of preventing the charge from infusing from the electroconductive substrate 501 to the photoconductive layer 502 when the free surface of the photoconductive layer 502 is charged with a certain polarity. When the free surface of the photoconductive layer 502 is charged with the opposite polarity, the charge infusion prevention layer 504 does not function. That is, the function of the charge infusion prevention layer 504 depends on polarity. To impart such function, the charge infusion prevention layer 504 contains atoms controlling electroconductivity in a relatively large amount in comparison with the photoconductive layer 502. The layer thickness of the charge infusion prevention layer 504 is preferably from 0.1 to 5 μm and more preferably from 0.3 to 4 μm and optimally from 0.5 to 3 μm in terms of the electophotographic characteristics and cost.

### Photoconductive Layer

The photoconductive layer 502 is optionally formed on an undercoating layer. The layer thickness of the photoconductive layer 502 is determined depending on the cost effectiveness and the target electrophotographic characteristics and preferably from 1 to 100 μm, more preferably from 20 to 50 μm and optimally from 23 to 45 μm.

The undercoating layer is generally made of a resin. Considering that the photoconductive layer 502 is applied to the resin, the resin preferably is hardly soluble in a typical organic solvent. Specific examples of such a resin include water-soluble resins, for example, polyvinyl alcohol, casein, sodium polyacrylate; alcohol-soluble resins, for example, copolymerized nylon, methoxymethylated nylon; and curable resins forming a three-dimensional network structure, for example, polyurethanes, melamine resins, phenol resins, alkyd-melamine resins and epoxy resins. Such an undercoat layer can be formed using a suitable solvent and coating method, as described for the above-mentioned photosensitive layer. The thickness of such an undercoat layer is suitably from 0 to 5 μm.

### Charge Transport Layer

The charge transport layer 506 of the photoreceptor 500 illustrated in FIG. 8D is a layer having a function of transporting charges when the photoconductive layer is functionally separated.

The charge transport layer 506 at least contains silicon atoms, carbon atoms, and fluorine atoms. Optionally, a-SiC(H, F, O) including hydrogen atoms and oxygen atoms can be also contained. The charge transport layer 506 has desired photoconductive characteristics, especially, charge retaining characteristics, charge generating characteristics and charge transport characteristics. In the present invention, it is particularly preferred that the charge transport layer 506 contains oxygen atoms.

The layer thickness of the charge transport layer 506 is determined depending on the cost effectiveness and the target electrophotographic characteristics and preferably from 5 to 50 μm, more preferably from 10 to 40 μm and optimally from 20 to 30 μm.

### Charge Transport Layer

The charge transport layer 505 is a layer having a function of generating charges when the photoconductive layer is functionally separated. The charge transport layer 505 at least contains silicon atoms but does not practically contain carbon atoms. Optionally, a-Si:H including hydrogen atoms is contained. The charge transport layer 505 has desired photoconductive characteristics, especially, charge generating characteristics and charge transport characteristics. The layer thickness of the charge transport layer 505 is determined depending on the cost effectiveness and the target electrophotographic characteristics and preferably from 0.5 to 15 μm, more preferably from 1 to 10 μm and optimally from 1 to 5 μm.

### Surface Layer

To the amorphous silicon photoreceptor for use in the present invention, the surface layer 503 can be optionally provided on the photoconductive layer 502 (or 506+505) formed on the substrate 501. The surface layer 503 has a free surface and is provided to improve anti-humidity, continuous repeated usage characteristics, electric durability, environment characteristics and durability in terms of the object of the present invention.

The layer thickness of the surface layer 503 is from 0.01 to 3 μm, preferably from 0.05 to 2 μm and optimally from 0.1 to 1 μm. When the layer thickness is too thin, the surface layer may disappear due to the abrasion of a photoreceptor during while using the photoreceptor. When the layer thickness is too thick, the electrophotographic characteristics such as residual voltage tend to deteriorate.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

In Examples, toners are manufactured by changing a toner composition ratio and the abrasion amount of an image bearing member is evaluated for each toner.

Sample toners are manufactured as follows.

### Toner A

The following components are placed in a reaction container equipped with a condenser, stirrer and a nitrogen introducing tube to conduct a reaction at 230° C. for 8 hours followed by another reaction with a reduced pressure of 10 to 15 mmHg for 5 hours:

| | |
|---|---|
| Adduct of bisphenol A with 2 mol of ethylene oxide | 229 parts |
| Bisphenol A with 3 mol of propion oxide | 529 parts |
| Terephthalic acid | 208 parts |
| Adipic acid | 46 parts |
| Dibutyl tin oxide | 2 parts |

44 parts of trimellitic anhydride is added in the container to conduct a reaction at 180° C. under normal pressure for 2 hours to synthesize a non-modified polyester resin.

The obtained non-modified polyester has a number average molecular weight of 2,500, a weight average molecular weight of 6,700, a glass transition temperature of 43° C. and an acid value of 25 mgKOH/g.

1,200 parts of water, 540 parts of carbon black (Printex 35 from Degussa AG) which has a dibutyl phthalate (DBP) oil absorption of 42 ml/100 mg and has a PH of 9.5, and 1200 parts of the non-modified polyester resin are mixed by a HENSCEL mixer (manufactured by Mitsui Mining Company, Limited). The thus obtained mixture is mixed and kneaded for 30 minutes at 150° C. using a two-roll mill followed by rolling and cooling. Then, the kneaded mixture is pulverized by a pulverizer (manufactured by Hosokawa Micron Corporation) to obtain a master batch.

In a reaction container equipped with a stirrer and a thermometer, 378 parts of the non-modified polyester resin, 110 parts of carnauba wax, 22 parts of a metal complex of salicylic acid (E-84 from Orient Chemical Industries Co., Ltd.) and 947 parts of ethyl acetate are mixed. The mixture is heated to 80° C. and kept at 80° C. for 5 hours while being agitated and then cooled down to 30° C. in 1 hour. Then, 500 parts of the master batch and 500 parts of ethyl acetate are added to the reaction container and mixed for 1 hour. Thus, a toner constituent solution is prepared.

1,324 parts of the toner constituent solution are transferred to a reaction container, and then C.I. Pigment Red and carnauba wax are dispersed using a bead mill (ULTRAVISCOMILL from AIMEX) under the following conditions:
Liquid feeding speed: 1 kg/hr
Disc rotation speed: 6 m/sec
Diameter of zirconia beads: 0.5 mm
Filling factor: 80% by volume
Repeat number of dispersion treatment: 3 times.

Thus, the wax liquid dispersion is obtained.

Next, 1,324 parts of 65% by weight of ethyl acetic acid solution of the non-modified polyester resin are added to the wax liquid dispersion. 3 parts of laminar inorganic mineral ore Montmorillonite (CLAYTON APA, manufactured by Southern Clay Product Co., Ltd.) at least part of which is modified by quaternary ammonium salt having benzyl group are added to 200 parts of a liquid dispersion obtained after 1 pass of ULTRAVISCOMILL under the same condition mentioned above and the mixture is stirred for 30 minutes by a T.K. HOMODISPER (manufactured by Tokushu Kika Kogyo Co., Ltd.) to obtain a liquid dispersion of a toner material.

The viscosity of the obtained liquid dispersion of toner material is measured as follows:

A shear force is imparted to the liquid dispersion of toner material at a shear speed of 30,000 s⁻¹ for 30 seconds at 25° C. by a parallel plate type rheometer (AR2000, manufactured by DA Instrument Inc.) equipped with a parallel plate having a diameter of 20 mm with a gap of 30 μm. Thereafter, the viscosity (Viscosity A) is measured when the shear speed is changed from 0 s⁻¹ to 70 s⁻¹ in 20 seconds. Also, the viscosity (Viscosity B) is measured for the liquid dispersion of toner material when a shear force is imparted thereto at a shear speed of 30,000 s⁻¹ for 30 seconds at 25° C. The results are shown in Table 1.

The following components are placed in a container equipped with a condenser, a stirrer and a nitrogen introducing tube to conduct a reaction at 230° C. at normal pressure for 8 hours followed by another reaction for 5 hours with a reduced pressure of 10 to 15 mmHg to synthesize an intermediate polyester resin:

| | |
|---|---|
| Adduct of bisphenol A with 2 mole of ethylene oxide | 682 parts |
| Adduct of bisphenol A with 2 mole of propylene oxide | 81 parts |
| Terephthalic acid | 283 parts |
| Trimellitic anhydrate | 22 parts |
| Dibutyl tin oxide | 2 parts |

The obtained intermediate polyester resin has a number average molecular weight of 2,100, a weight average molecular weight of 9,500, a glass transition temperature of 55° C., an acid value of 0.5 mgKOH/g and a hydroxyl value of 51 mgKOH/g.

Next, the following components are placed in a container equipped with a condenser, a stirrer and a nitrogen introducing tube to conduct a reaction at 100° C. for 5 hours to synthesize a prepolymer:

| | |
|---|---|
| Intermediate polyester resin | 410 parts |
| Isophorone diisocyanate | 89 parts |
| Ethyl acetate | 500 parts |

The obtained prepolymer has an isolated isocyanate weight % of 1.53%.

The following is placed and mixed in a reaction container equipped with a stirrer and a thermometer for a reaction at 50° C. for 5 hours to synthesize a ketimine compound:

| | |
|---|---|
| Isophorone diamine | 170 parts |
| Methyl ethyl ketone | 75 parts |

The amine value of the obtained ketimine compound is 418 mgKOH/g.

Then, 749 parts of the liquid dispersion of toner material, 115 parts of the prepolymer and 2.9 parts of the ketimine compound are placed in the reaction container and the mixture is mixed for 1 minute using a TK HOMOMIXER (manufactured by Tokushu Kika Kogyo Co., Ltd.) at 5,000 rpm to obtain an oil phase liquid mixture.

The following components are placed in a container equipped with a stirrer and a thermometer and agitated for 15 minutes at 400 rpm to obtain an emulsion.

| | | |
|---|---|---|
| Water | 683 | parts |
| Sodium salt of sulfate of an adduct of methacrylic acid with | 11 | parts |
| ethyleneoxide (Reactive emulsifying agent, EREMINOR | | |
| RS-30 from Sanyo Chemical Industries Ltd.) | | |
| Styrene | 83 | parts |
| Methacrylic acid | 83 | parts |
| Butylacrylate | 110 | parts |
| Ammonium persulfate | 1 | part |

Thereafter, the emulsion is heated to 75° C. to conduct a reaction for 5 hours. Then, 30 parts of a 1 weight 9 aqueous solution of ammonium persulfate are added to the emulsion and the mixture is further aged at 75° C. for 5 hours to prepare resin particulate liquid dispersion.

### Particle Diameter of Dispersoid Particle and Distribution of Dispersion Particle Diameter of Toner Composition Liquid

In the present invention, the particle diameter of dispersoid and dispersion particle diameter distribution of the toner composition liquid is measured by MicroTrack UPA 150 (manufactured by Nikkiso Co., ltd.) and analyzed by Analysis software (MicroTrack Particle Size Analyzer Ver. 10.1.2-016EE, manufactured by Nikkiso Co., ltd.). Specifically, toner composition liquid is set in a sample glass vessel (30 ml) and then the solvent for use in preparing the toner composition liquid is added thereto to prepare a 10% by weight liquid dispersion. The obtained liquid dispersion is subject to dispersion treatment for 2 minutes by using an ultrasonic dispersion device (W-113MK-II, manufactured by Honda Electronics Co., Ltd.).

After measuring the background by the solvent for use in the toner composition liquid to be measured, the liquid dispersion is dropped thereto and the dispersion particle diameter is measured under the condition that the value of sample loading of the measuring device ranges from 1 to 10. In this method, it is suitable that measuring is performed under the range mentioned above in terms of the measuring reproducibility. The dropping amount of the liquid dispersion is adjusted to obtain the values of the sample loading.

Measuring and analysis conditions are set as follows.
Distribution display: volume
Selection of particle size division: standard
Number of channels: 44
Measuring time: 60 seconds
Number of measuring times: 1
Transmission property of particle: transmission
Fraction index of particle: 1.5
Particle form: non-spherical
Density: 1 g/3 cm³
Value of the solvent fraction index: value for the solvent for use in the toner component liquid listed in “Guideline relating to the input condition when measuring” issued by Nikkiso Co., Ltd.

83 parts of the resin particulate liquid dispersion are mixed and stirred with the following components to obtain an aqueous medium:

| | |
|---|---|
| Water | 990 parts |
| 48.5% by weight aqueous solution of sodium dodecyldiphenyl | 37 parts |
| etherdisulfonate (EREMINOR MON-7 from Sanyo | |
| Chemical Industries, Ltd.) | |
| 1% by weight aqueous solution of polymer dispersing agent | 135 parts |
| carboxymethyl cellulose sodium (CELLOGEN BS-H-3, | |
| manufactured by Dai-ichi Kogyo Seiyaku Kogyo Co., Ltd.) | |
| Ethyl acetate | 90 parts |

Next, 867 parts of the oil phase liquid mixture is added to and mixed with 1,200 parts of the aqueous medium using a TK HOMOMIXER at 13,000 rpm for 20 minutes to prepare a liquid dispersion (emulsified slurry).

Next, the emulsion slurry is placed in a reaction container equipped with a stirrer and a thermometer to remove the solvent at 30° C. for 8 hours. Thereafter, the resultant is aged at 45° C. for 4 hours to obtain a dispersion slurry.

100 parts of the dispersion slurry are filtered under a reduced pressure. Thereafter, 100 parts of deionized water are added to the thus prepared filtered cake and the resultant is mixed for 10 minutes at 12,000 rpm by a TKHOMOMIXER and then filtered. Next, 10% by weight hydrochloric acid is added to the resultant filtered cake to adjust the pH to be 2.8 followed by mixing for 10 minutes at 12,000 rpm by a TK HOMOMIXER and the mixture is then filtered.

Furthermore, 300 parts of deionized water are added to the obtained filtered cake and the resultant is mixed for 10 minutes at a rotation of 12,000 rpm by a TK HOMOMIXER and then filtered. This washing is repeated twice to obtain a final filtered cake. The final filtered cake is dried at 45° C. for 48 hours using a circulating drier. The obtained dried cake is filtered using a screen having a mesh of 75 μm to obtain mother toner particles.

1 part of resin particulates having an average primary particle diameter of 150 nm (acryl non-cross-linking type simple dispersion resin particle MP-1451, manufactured by Soken & Engineering Co., Ltd.) is added to the thus obtained mother toner particles. Then, 1 part of silica (H2000, manufactured by Clariant Japan, also H1303 and H3004, both manufactured by Clariant Japan can be used) and 1 part of titanium oxide (JMT 150IB, manufactured by Tayca Corporation, also other products of Tayca Corporation such as MT150AI, SMT150AI, SMT150AFM can be used) are added thereto followed by mixing by a HENSCHEL MIXER to obtain Toner A.

The physical property of the thus manufactured Toner A is shown in Table 1.

In this manufacturing, acryl non-cross-linking type simple dispersion resin particle MP-1451 (manufactured by Soken & Engineering Co., Ltd.) is used as the resin particulates. Other acryl non-cross-linking type simple dispersion resin particles such as MP300, MP2000, MP2701, MP5000, MP5500 and MP4009 (all manufactured by Soken & Engineering Co., Ltd.) can be also used as the resin particulates having an average particle diameter of from 60 to 600 nm.

### Toner B

Toner B is manufactured in the same manner as in manufacturing of Toner A except that the addition amount of the laminar inorganic mineral ore (Product name: CLAYTON APA) is changed from 3 parts to 2 parts. The physical property of Toner B is shown in Table 1.

### Toner C

Mother toner of Toner A, which is obtained before external additives are added, is classified to increase the amount of coarse powder to obtain mother toner of Toner C having a large average particle diameter. Thereafter, mother toner of Toner C is subject to the same external addition treatment as in Toner A to obtain Toner C. The physical property of Toner C is shown in Table 1.

Toner D is manufactured in the same manner as in manufacturing of Toner A except that 3 parts of resin particulates having an average primary particle diameter of 400 nm (acryl non-cross-linking type simple dispersion resin particle MP-1000, manufactured by Soken & Engineering Co., Ltd.) is added in place of resin particulates having an average primary particle diameter of 150 nm (acryl non-cross-linking type simple dispersion resin particle MP-1451, manufactured by Soken & Engineering Co., Ltd.). The physical property of Toner D is shown in Table 1.

### Toner E

Toner E is manufactured in the same manner as in manufacturing of Toner A except that CLAYTON APA is changed to a laminar inorganic mineral ore Montmorillonite (CLAYTON HY, manufactured by Southern Clay Product Co., Ltd.) at least part of which is modified by an ammonium salt having polyoxyethylene group. The physical property of Toner E is shown in Table 1.

### Toner F

Toner F is manufactured in the same manner as in manufacturing of Toner A except that the addition amount of CLAYTON APA is changed from 3 parts to 1.4 parts. The physical property of Toner F is shown in Table 1.

### Toner G

Toner G is manufactured in the same manner as in manufacturing of Toner A except that the addition amount of CLAYTON APA is changed from 3 parts to 6 parts. The physical property of Toner G is shown in Table 1.

### Toner H

Mother toner of Toner F, which is obtained before external additives are added, is classified to increase the amount of fine powder to obtain mother toner of Toner H having a small average particle diameter. Thereafter, mother toner of Toner H is subject to the same external addition treatment as in Toner A to obtain Toner H. The physical property of Toner H is shown in Table 1.

### Toner I

Toner I is manufactured in the same manner as in manufacturing of Toner A except that CLAYTON APA (manufactured by Southern Clay Product Co., Ltd.) is changed to a non-modified laminar inorganic mineral ore Montmorillonite (Product name: Kunipia, manufactured by Kunimine Inductries Co., Ltd.). The physical property of Toner I is shown in Table 1.

### Toner J

Toner J is manufactured in the same manner as in manufacturing of Toner A except that the resin particulate is changed to resin particulates having an average primary particle diameter of 800 nm (acryl non-cross-linking type simple dispersion resin particle MP-1600, manufactured by Soken & Engineering Co., Ltd.). The physical property of Toner J is shown in Table 1.

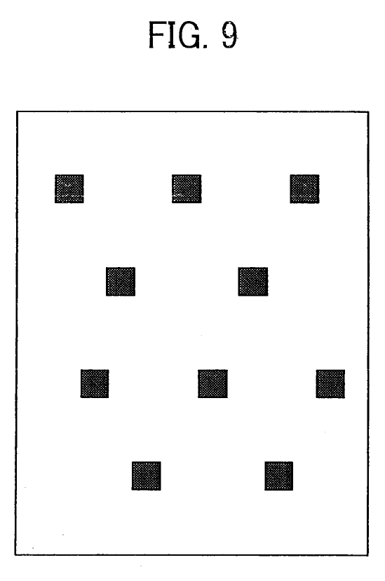

Images are formed using Toner A (Example 1), Toner B (Example 2), Toner C (Example 3), Toner D (Example 4), Toner E (Example 5), Toner F (Example 6), Toner G (Example 7), Toner H (Comparative Example 1), Toner I (Comparative Example 2) and Toner J (Comparative Example 3) manufactured as described above by the following method and conditions. The image bearing member for use in the image formation is the image bearing member having a surface layer in which a filler is dispersed. The evaluation results are shown in Table 1.
(1) Toner A and the devices for use in the experiment are left in the environment room at 25° C. and 50% RH for one day.
(2) The process cartridge of a printer (Imagio neo C600, manufactured by Ricoh Co., Ltd.) is remodeled such that a cleaning assistance brush, a cleaning blade, a lubricant application brush to which a solid lubricant formed of zinc stearate and molded to have a bar form is attached, and a lubricant smoothing blade are arranged to be in contact with the image bearing member in this sequence after primary transfer relative to the rotation direction of the image bearing member.
(3) The cleaning blade has an elasticity of 70% and a thickness of 2 mm and is in contact with the image bearing member with a contact angle of 20° in a counter manner.
(4) The toner in the process cartridge is removed so that only carrier is left in the developing device.
(5) 28 g of a sample toner is set in the developing device accommodating only the carrier to obtain 400 g of a developing agent having a toner density of 7%.
(6) The remodeled process cartridge is assembled into the main body of Imagio neo C600 and the developing device is operated without image formation for 5 minutes while the development sleeve is rotated at a linear speed of 300 m/s.
(7) The development sleeve and the image bearing member are rotated in a trailing manner at 300 mm/s and the charging voltage and the developing bias are adjusted such that the toner on the image bearing member is from 0.55 to 0.65 mg/cm².
(8) Under the development condition described above, the transfer current is adjusted such that the transfer ratio is from 94 to 98%. With the set values mentioned above, a chart illustrated in FIG. 9 having an image area ratio of 5% is continuously printed on 100,000 sheets.
(9) After printing, the state of toner attachment to the lubricant is observed with naked eyes.
(10) The experiment described above is repeated for other toners, i.e., Toner B to Toner J.

### Comparative Example 4

Experiment of Comparative Example 4 is performed using Toner A in the same manner as described above except that the process cartridge of a printer (Imagio neo C600, manufactured by Ricoh Co., Ltd.) in (2) described above is remodeled such that a cleaning assistance brush and a lubricant application brush to which a solid lubricant formed of zinc stearate and molded to have a bar form is attached are arranged to be in contact with the image bearing member in this sequence after primary transfer relative to the rotation direction of the image bearing member.

### Evaluation

The toner attachment and the produced images are evaluated and ranked as follows:
Excellent (E): it is confirmed that the toner is attached to the lubricant but no abnormal image is produced.
Good (G): the toner is attached to the lubricant to a degree that the toner can be wiped off by a finger but no abnormal image is produced.
Bad (B): the toner is attached to the lubricant, which causes production of abnormal images.

The evaluation results are shown in Table 1. As seen in the experiment results, the toner is not attached to the lubricant in Examples 1 to 7 in which the toner for use in the present invention is used. Even when the toner is attached to the lubricant, the attached toner is easily removed and images formation is stably performed without producing abnormal images.

By contrast, it is confirmed that the toner is attached to the lubricant in Comparative Examples 1 to 4, which prevents stable image formation.

TABLE 1

| | Examples | | | | | | | Comparative Examples | | | |
|---|---|---|---|---|---|---|---|---|---|---|---|
| | 1 | 2 | 3 | 4 | 5 | 6 | 7 | 1 | 2 | 3 | 4 |
| Volume | 4.0 | 3.8 | 5.2 | 4.0 | 4.6 | 4.1 | 3.3 | 2.8 | 4.9 | 4.0 | 4.0 |
| Average | | | | | | | | | | | |
| particle | | | | | | | | | | | |
| diameter Dv | | | | | | | | | | | |
| (μm) | | | | | | | | | | | |
| Volume | 3.4 | 3.4 | 4.5 | 3.4 | 4.4 | 2.8 | 2.8 | 2.1 | 4.7 | 3.4 | 3.4 |
| Average | | | | | | | | | | | |
| particle | | | | | | | | | | | |
| diameter Dv | | | | | | | | | | | |
| (μm) | | | | | | | | | | | |
| Dv/Dn | 1.18 | 1.12 | 1.16 | 1.18 | 1.05 | 1.46 | 1.18 | 1.33 | 1.04 | 1.18 | 1.18 |
| Number of | 19.0 | 22.4 | 6.4 | 19.0 | 13.4 | 24.6 | 34.5 | 49.6 | 3.5 | 19.0 | 19.0 |
| particles | | | | | | | | | | | |
| having | | | | | | | | | | | |
| particle | | | | | | | | | | | |
| diameter of | | | | | | | | | | | |
| not greater | | | | | | | | | | | |
| than 2 μm (% | | | | | | | | | | | |
| by number) | | | | | | | | | | | |
| Average | 0.961 | 0.973 | 0.952 | 0.961 | 0.983 | 0.967 | 0.950 | 0.951 | 0.978 | 0.961 | 0.961 |
| Circularity | | | | | | | | | | | |
| BET | 3.8 | 3.2 | 3.5 | 3.8 | 1.4 | 4.3 | 4.9 | 5.1 | 1.3 | 3.8 | 3.8 |
| specific | | | | | | | | | | | |
| surface | | | | | | | | | | | |
| area (m²/g) | | | | | | | | | | | |
| BET/Dv | 0.95 | 0.84 | 0.67 | 0.95 | 0.30 | 1.05 | 1.48 | 1.82 | 0.27 | 0.95 | 0.95 |
| (m²/g · μm) | | | | | | | | | | | |
| Average | 150 | 150 | 150 | 400 | 150 | 150 | 150 | 150 | 150 | 800 | 150 |
| primary | | | | | | | | | | | |
| particle | | | | | | | | | | | |
| diameter of | | | | | | | | | | | |
| resin | | | | | | | | | | | |
| particulate | | | | | | | | | | | |
| (nm) | | | | | | | | | | | |
| Addition | 1 | 1 | 1 | 1 | 1 | 1 | 1 | 1 | 1 | 1 | 1 |
| amount of | | | | | | | | | | | |
| resin | | | | | | | | | | | |
| particulate | | | | | | | | | | | |
| (parts by | | | | | | | | | | | |
| weight) | | | | | | | | | | | |
| Evaluation | E | E | G | G | G | G | G | B | B | B | B |
| on results | | | | | | | | | | | |

This document claims priority and contains subject matter related to Japanese Patent Applications Nos. 2007-238044 and 2007-277796, filed on Sep. 13, 2007 and Oct. 25, 2007, respectively, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by letters patent of the United States is:

1. An image forming apparatus comprising:
an image bearing member configured to bear a latent electrostatic image;
a charging device configured to charge the image bearing member;
an irradiating device configured to irradiate the image bearing member with light to form the latent electrostatic image;
a developing device comprising a toner and configured to develop the latent electrostatic image with the toner to form a visualized image;
a transfer device configured to transfer the visualized image to a recording medium;
a lubricant application device to apply a lubricant to a surface of the image bearing member;
a cleaning device configured to clean the surface of the image bearing member;
wherein the toner has a ratio A of from 0.3 to 1.7 obtained by a following Relationship (1), particulates P comprising resin particulates and inorganic particulates are added to the toner and the resin particulates have an average primary particle diameter of from 60 to 600 nm,
ratio A=Mother toner BET specific surface area/Mother toner volume average particle diameter Relationship (1).

2. The image forming apparatus according to claim 1, wherein the toner has a volume average particle diameter of from 3.0 to 5.5 μm.

3. The image forming apparatus according to claim 1, wherein the resin particulates having an average primary particle diameter of from 60 to 600 nm are attached to the toner in an amount of from 0.5 to 4.0% by weight.

4. The image forming apparatus according to claim 1, wherein the toner comprises toner particles having a particle diameter of not greater than 2 μm in an amount of from 1 to 25% by number.

5. The image forming apparatus according to claim 1, wherein the toner comprises toner particles having an average circularity of from 0.950 to 0.980.

6. The image forming apparatus according to claim 1, wherein the toner comprises toner particles having a circularity of from 0.97 to 1.0 in an amount of less than 40%.

7. The image forming apparatus according to claim 1, wherein the toner comprises toner particles comprising the inorganic particulates having an average primary particle diameter of from 1 to 50 nm in an amount of from 0.5 to 4.0% by weight.

8. The image forming apparatus according to claim 1, wherein the toner is granulated from an aqueous system and comprises a binder resin, a coloring agent, a laminate inorganic mineral in which at least part of ions between metal cation layers is modified by an organic cation.

9. The image forming apparatus according to claim 1, wherein the lubricant application device is provided on a downstream side from the cleaning device and an upstream side from the charging device relative to a rotation direction of the image bearing member.

10. The image forming apparatus according to claim 1, further comprising a lubricant smoothing device which is provided on a downstream side from the lubricant application device and on a upstream side from the charging device relative to a rotation direction of the image bearing member.

11. The image forming apparatus according to claim 1, wherein the charging device employs a corona discharging system.

12. The image forming apparatus according to claim 1, further comprising a discharge product removing device which performs controlling removing a discharge product on the surface of the image bearing member when a continuous printing number of an image pattern having an image area ratio of not greater than 5% reaches a particular number.

13. The image forming apparatus according to claim 1, further comprising a toner spitting control device configured to supply the toner in a predetermined amount from the developing device to the surface of the image bearing member when a continuous printing number of an image pattern having an image area ratio of not greater than a predetermined ratio reaches a particular number.

14. The image forming apparatus according to claim 1, wherein the image bearing member is a photoreceptor in which a filler is dispersed.

15. The image forming apparatus according to claim 1, wherein the image bearing member is one of an organic photoreceptor having a surface layer which is reinforced by a filler, an organic photoreceptor using a cross-linking type charge transport material and an organic photoreceptor using a cross-linking charge transport material and having a surface layer which is reinforced by a filler.

16. The image forming apparatus according to claim 1, wherein the image bearing member is an amorphous silicon photoreceptor.

17. An image forming method comprising:
uniformly charging a surface of an image bearing member;
irradiating the surface of the image bearing member to form a latent electrostatic image;
developing the latent electrostatic image with a toner to obtain a toner image;
transferring the toner image to a transfer medium;
applying a lubricant to the surface of the image bearing member; and
cleaning the surface of the image bearing member,
wherein the toner has a ratio A of from 0.3 to 1.7 obtained by a following relationship (1), particulates P comprising resin particulates and inorganic particulates are added to the toner and the resin particulates have an average primary particle diameter of from 60 to 600 nm,
ratio A=Mother toner BET specific surface area/Mother toner volume average particle diameter Relationship (1).

18. The image forming method according to claim 17, wherein the toner has a volume average particle diameter of from 3.0 to 5.5 μm.

19. The image forming method according to claim 17, wherein charging is performed by a corona discharging system.

20. The image forming method according to claim 17, further comprising removing a discharge product on the surface of the image bearing member.
